(19) United States
(12) Patent Application Publication
(10) Pub. No.: US 2005/0241667 A1
(43) Pub. Date: Nov. 3, 2005

(54) Ultrasonic cleaning

(76) Inventors: Jean-Francois Bodet, Mason, OH (US); William Michael Scheper, Lawrenceburg, IN (US); Christiaan Arthur Jacques Kamiel Thoen, West Chester, OH (US); Tim Maria Joris Van Hauwermeiren, Ramsdonk (BE); Lieven Richard Deketele, Zulte (BE); Jean Wevers, Steenhuffel (BE)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/062,929

(22) Filed: Jul. 14, 2005

Related U.S. Application Data
(63) Continuation of application No. 10/147,768, filed on May 16, 2002, now abandoned.
Application No. 10/147,768 is a continuation of application No. PCT/US00/31432, filed on Nov. 15, 2000.
Application No. 10/147,768 is a continuation-in-part of application No. 09/831,195, filed on May 7, 2001, now Pat. No. 6,624,133.
Application No. 09/831,195 is a continuation of application No. PCT/US99/27200, filed on Nov. 16, 1999.
(60) Provisional application No. 60/165,862, filed on Nov. 16, 1999.
(60) Provisional application No. 60/108,547, filed on Nov. 16, 1998.

(51) Int. Cl. B08B 3/12

(52) U.S. Cl. 134/1

(57) ABSTRACT

The invention relates to a process of cleaning a substrate, the process comprising a first step of providing a cleaning solution and a hand-held implement, the process further comprising a second step of applying the solution onto the substrate with the implement, characterised in that the implement has an active part vibrating at a frequency of at least 20 kHz with an amplitude of at least 10 μm and up to 100 μm, and whereby the substrate is fibrous or a hard domestic surface.

### RELATED APPLICATIONS

This application is a continuation of International Application No. PCT/US00/31432 filed Nov. 15, 2000, which claims priority to U.S. Provisional Application Ser. No. 60/165,862 filed Nov. 16, 1999.

### TECHNICAL FIELD

The present invention relates to a process for cleaning of the type using ultrasonic vibration.

### BACKGROUND OF THE INVENTION

Ultrasonic vibration is being used in industry for cleaning of soiled substrates. In particular, this is done by insertion of such substrates in an aqueous bath submitted to ultrasonic vibration. Indeed, such vibration removes soils from the substrate. Such a process is for example mentioned in U.S. Pat. No. 4,494,748. An other area of use of ultrasonic vibration for cleaning is in the cleaning of teeth or dentures, where an vibrating implement is placed in contact with the soiled teeth or denture, the vibration removing the soil. Such a process is for example mentioned in U.S. Pat. No. 5,927,977.

The present invention concerns a process of cleaning a substrate, the process comprising a first step of providing a cleaning solution and a hand-held implement, the process further comprising a second step of applying the solution onto the substrate with the implement.

Among the advantages of cleaning using ultrasonic vibration is the reduced effort and time required to remove soils when compared to traditional purely mechanical methods. More particularly, ultrasonic vibration is functional where other methods would be likely to fail, particularly when cleaning complex surfaces. Indeed, such surfaces may simply be placed in an aqueous bath, the aqueous solution being vibrated, so that all of the immersed surfaced is cleaned. In the particular domain of teeth cleaning, where the ultrasonic bath is not practical, the use of an ultrasonic implement applied directly onto soils allows for rapid and efficient cleaning.

While having these and other advantages, cleaning processes using ultrasonic vibration have disadvantages. For example, the traditional aqueous bath transmitting ultrasonic vibration requires relatively large electrical power supply in order to vibrate all of the liquid in which the soiled substrate is immersed.

The invention seeks to provide a process of cleaning a substrate, whereby the removal of soils will be provided in a reduced time and with reduced efforts, while requiring a limited electrical power.

### SUMMARY OF THE INVENTION

In accordance with the invention this aspect is accomplished in a process of cleaning a substrate, the process comprising a first step of providing a cleaning solution and a hand-held implement, the process further comprising a second step of applying the solution onto the substrate with the implement, characterised in that the implement has an active part vibrating at a frequency of at least 20 kHz with an amplitude of at least 10 μm and up to 100 μm, and whereby the substrate is fibrous or a hard domestic surface.

### BRIEF DESCRIPTION OF THE DRAWINGS

FIG. 1 is a perspective view of a hand-held, ultrasonic device, with a cleaning solution storage means which is adapted to be removably mounted in the device. Also shown are a removably mountable cleaning head and an additional cleaning solution storage means.

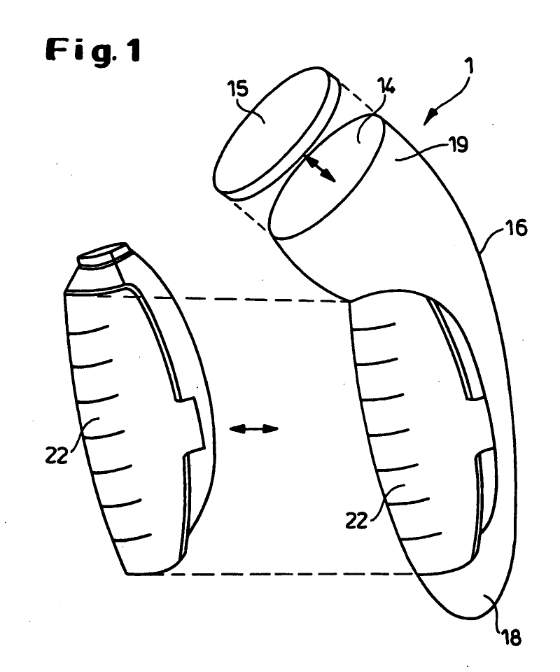

FIG. 2 is a perspective view of two different hand-held, pen-shaped ultrasonic devices, which are used in the invention to impart ultrasonic waves onto a stain or soil.

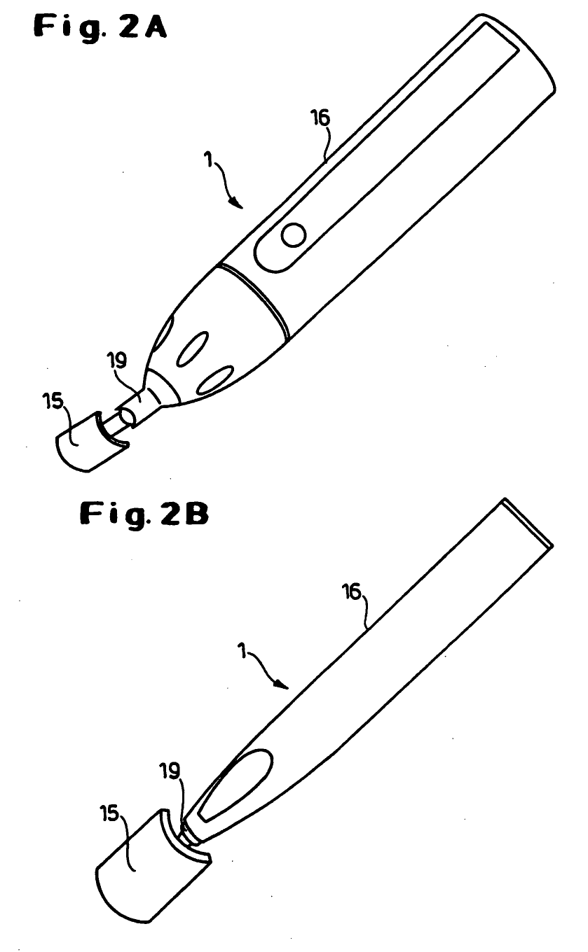

FIG. 3 is a perspective view of a hand-held, pen-shaped ultrasonic device, which is shown imparting ultrasonic waves onto a soil.

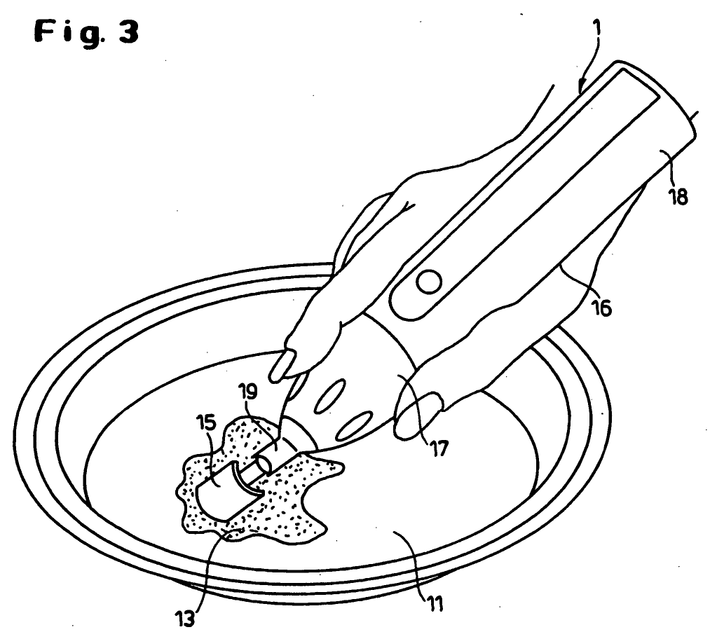

FIG. 4 is a perspective an ultrasonic device, which are used in the invention to impart ultrasonic waves onto a stain or soil. The ultrasonic generator and the power source are in a second housing which is associated with the cleaning head which is in a first housing.

FIG. 5 is a perspective view of a four different hand-held, glue-gun and vacuum like-shaped ultrasonic device. Also shown is a detachably mounted cartridge which would contain cleaning solution.

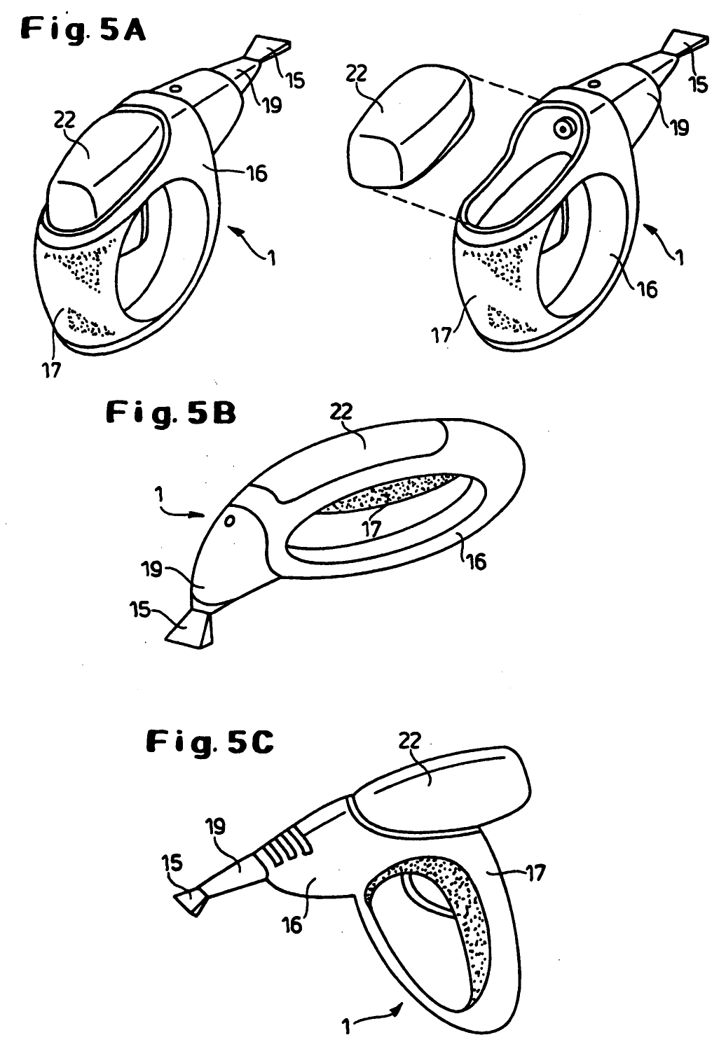

FIG. 6 is a perspective view of a hand-held, pen-shaped ultrasonic device, and a recharging cradle which acts as an additional reservoir for cleaning solution. The pen shaped ultrasonic device is detachably mounted from the recharging cradle.

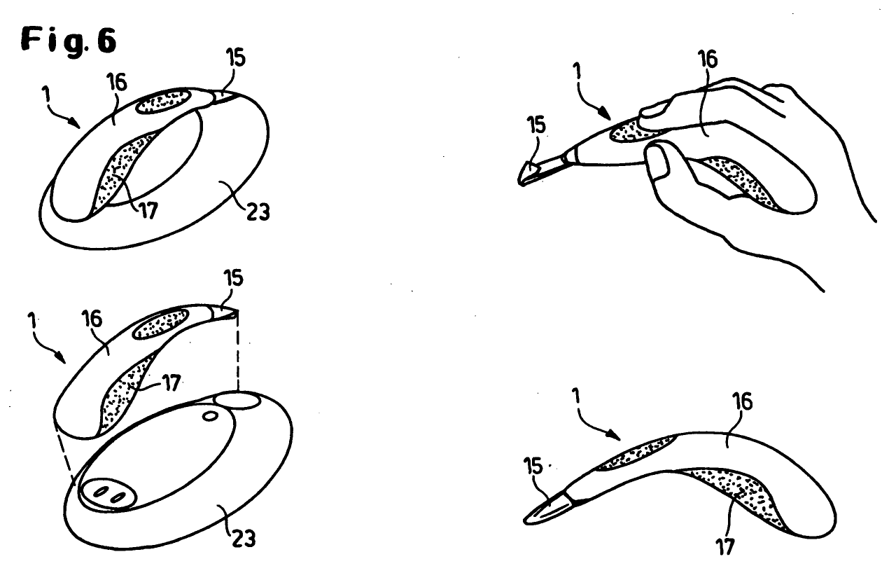

FIG. 7 is a perspective view and a exploded view of a of a hand-held, glue gun or drill like ultrasonic device. The detachable reservoir is show how it mounts in the device as well as where the cleaning solution exits from the device onto the surface to be cleaned.

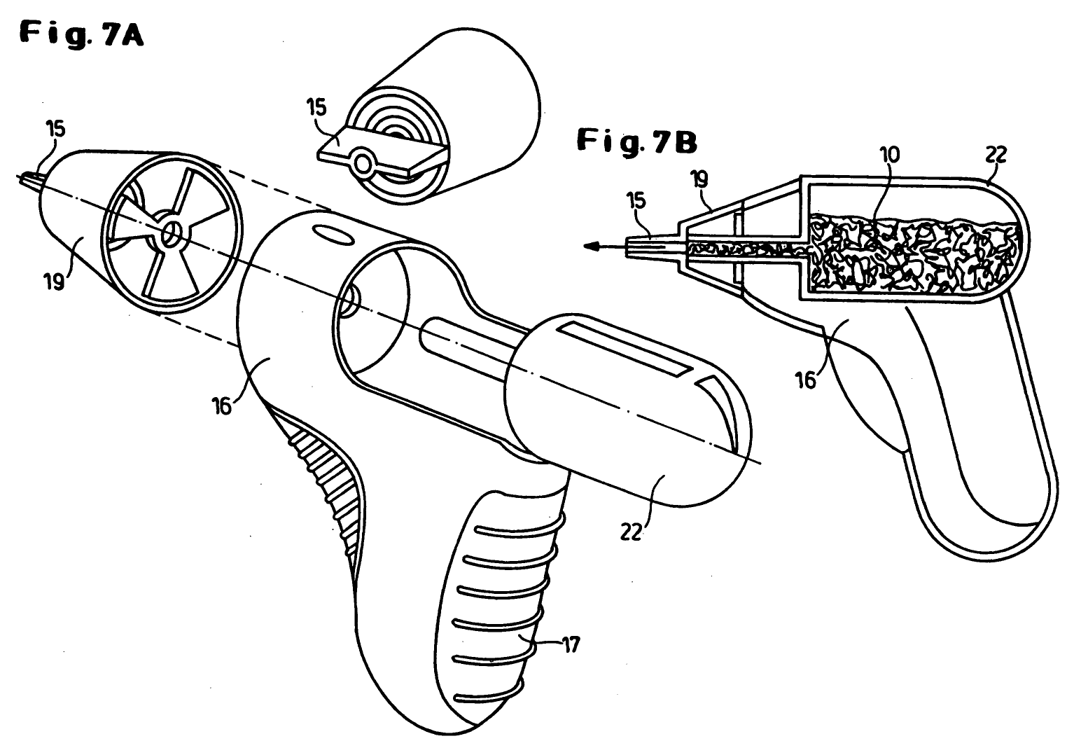

FIG. 8 is a perspective view of a hand-held, pen-shaped ultrasonic device, which is shown additionally, to indicate how the cartridge containing the cleaning solution is removed/attached to the device.

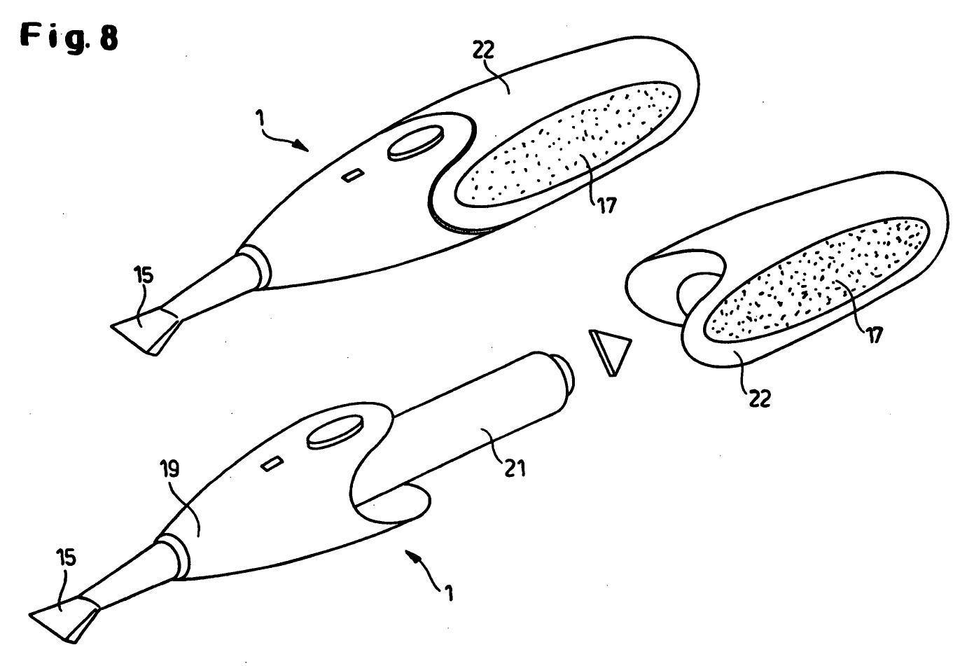

FIG. 9 is a perspective, and two exploded views view of a hand-held, pen-shaped ultrasonic device, which is shown indicating how the cartridge containing the cleaning solution is removed/attached to the device and how and where the cleaning solution is dispensed for use on the surface to be cleaned.

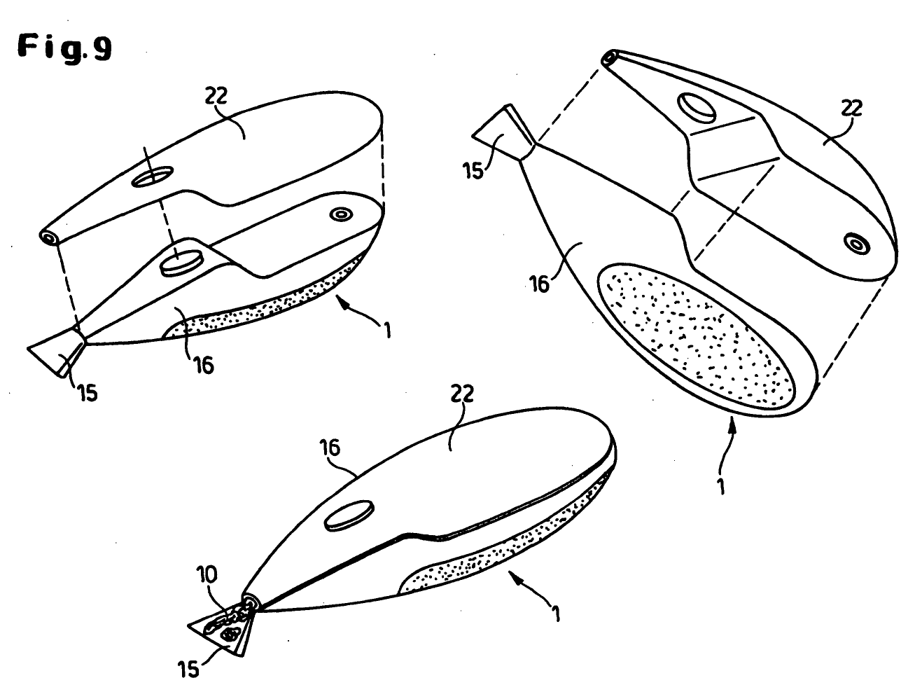

FIG. 10 is a perspective view of a two hand-held, pen-shaped ultrasonic device, which are shown imparting ultrasonic waves onto a surface. Also shown is a double sided ultrasonic device where each end is designed for use on a different type of surface, such as fabric (like clothing, furniture) and hard kitchen surfaces, such as floors, dishes, etc.

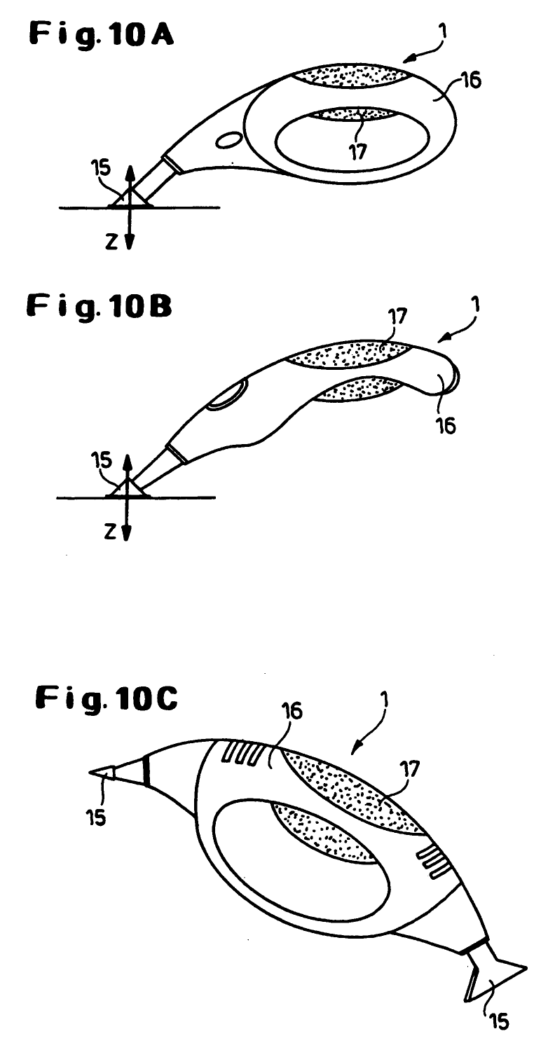

FIG. 11 is a perspective view of a hand-held ultrasonic device, and a recharging cradle and how the arrangement is inserted into a mains wall socket. The ultrasonic device is detachably mounted from the recharging cradle.

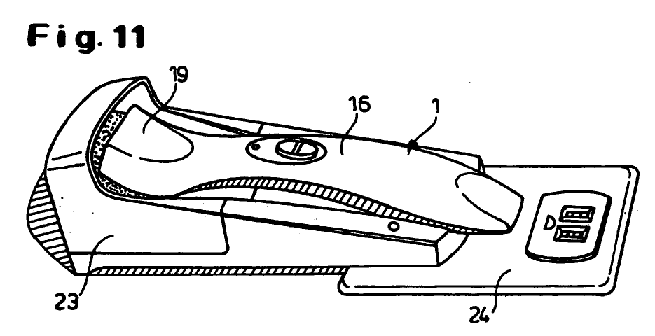

FIG. 12 is a perspective view of a hand-held ultrasonic device showing a detachable and rechargeable batter for providing power to the hand-held ultrasonic device, and how the rechargeable batter is inserted into a mains wall socket to recharge.

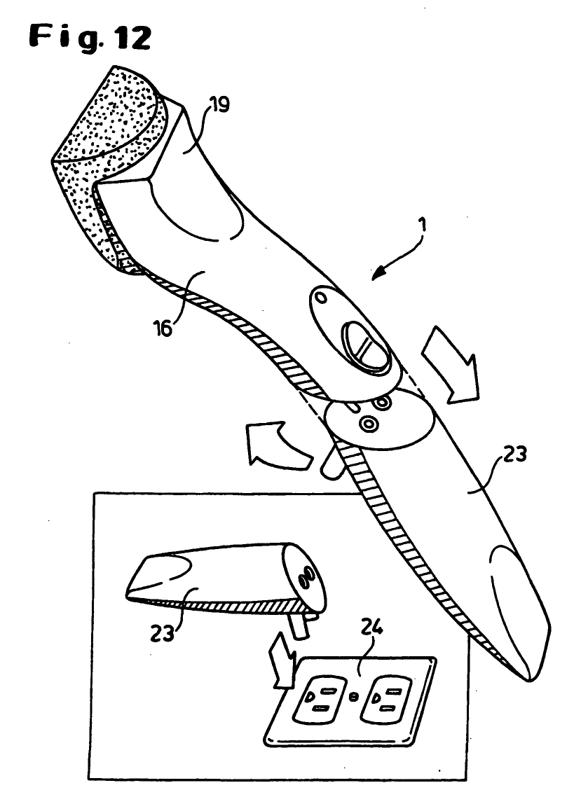

FIG. 13 is a perspective view of a hand-held ultrasonic device similar to that of FIG. 11, except that the hand-held ultrasonic device and recharging cradle are free standing and the arrangement is inserted connected to mains wall socket via a electrical lead. The ultrasonic device is detachably mounted from the recharging cradle.

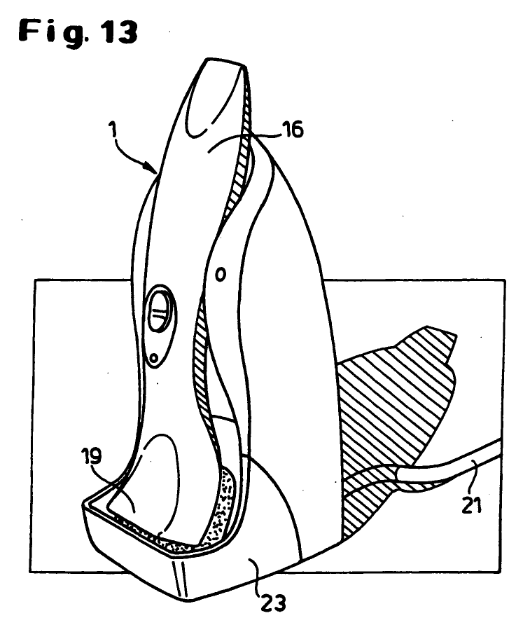

### DETAILED DESCRIPTION OF THE INVENTION

The present invention relates to process of cleaning a substrate, the process comprising a first step of providing a cleaning solution and a hand-held implement.

By cleaning solution, it should be understood a solution which preferably comprises surfactants, builders or bleaching species, as well as other ingredients typically used in laundry or dish washing liquids described in the art. In a particular embodiment, the cleaning solution is mostly composed of water, and may even be composed of water only.

In a particular embodiment, the cleaning solution may be heated to allow for further improved removing of the soil.

By hand-held, it should be understood that the implement can be manipulated with one hand only. Typically, the implement will have an elongated shape, similar to the shape of electrical screwdrivers for example.

The process further comprising a second step of applying the solution onto the substrate with the implement. This my be obtained by brushing the solution onto the substrate to be treated, for example. Preferably the cleaning composition contains a cleaning agents, which is present in the cleaning composition in an effective amount, more preferably from about 0.0001% to about 60%, even more preferably from about 0.001% to about 30%, even more preferably still from about 0.005% to about 10%, even more preferably still from about 0.01% to about 5% by weight. These cleaning compositions are exemplified in greater detail hereafter.

The implement has an active part vibrating at a frequency of at least 20 kHz with an amplitude of at least 10 μm and up to 100 μm. Indeed, the implement has an active part which vibrates at an ultrasonic frequency. It should be noted that the ultrasonic frequency may be superposed to other lower frequencies. Although the ultrasonic frequency is of at least 20 kHz, the implement was found to function more efficiently with higher frequencies of at least 30 kHz, more preferably of at least 40 kHz and most preferably of at least 50 kHz. As for the amplitude, it was found that an amplitude of less than 10 μm would not be satisfactory, whereas an amplitude of more than 100 μm may cause damage on particular types of fragile substrates. Preferably, the amplitude is of at least 20 μm, more preferably of at least 30 μm, and even more preferably of at least 50 μm.

The substrate or surface is fibrous or a hard domestic surface. A “fibrous surface” includes any fabric surface, such as clothing; such as shirts, pants, gloves, hats, shoes; upholstery, such as furniture, car seats; linen, curtains, drapes, carpets, rugs, tapestries, pads, wipes, etc. The “fibrous surface” can be, for example, composed of natural fibers such as cotton, wool, silk; artificial fibers, such as polyesters, rayon, dacron; or blends of natural and artificial fibers, such as polycotton blends. A “hard domestic surface”, includes any surface which is traditionally regarded as an inanimate hard surface in a domestic environment, such as, tableware, plates, glasses, cutlery, pots and pans, and also includes other surfaces such as kitchen counter tops, sinks, glass, windows, enamel surfaces, metal surfaces, tiles, bathtubs, walls, ceilings, floors etc. Indeed, it was found that the use of an implement according to the invention was significantly improving the removal of domestic stains due to food, grass, greasy materials or body soils for example.

In a preferred embodiment, the hand-held implement has at least two configurations, a first configuration where the active part is hard, and a second configuration where the active part is not hard. Indeed, it was found that use of a hard active part was preferred when using the implement onto fibrous substrates for example, whereas use of a not hard active part is preferred when using the implement onto hard surfaces. In this manner, by having the 2 configurations available, the implement may be used efficiently onto a wide range of different substrates. Clearly, this principle may be expended to a larger number of configurations, depending on the degree of customisation required.

In a preferred embodiment, the second configuration described above is obtained by adding an extra element to the implement in the first configuration. The extra element may simply be sleeved around the implement in the first configuration for example. Such an extra element advantageously comprises a porous, scouring, fibrous, absorbing or sponge material.

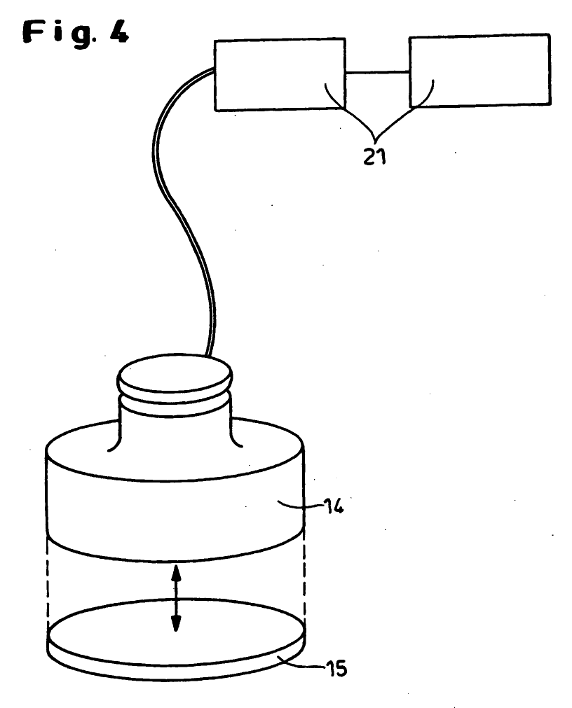

The invention refers to hard surfaces or to a hard active part. Hardness is hereby defined by the longitudinal wave velocity of the material considered, the longitudinal wave velocity being typically of more than 3000 m/s for a hard material, this including woods, engineered composites, engineered ceramics, engineered alloys and porous ceramics. This is explained in “Materials selection in mechanical design” by M. F. Ashby, Pergamon Press, 1992, Chapter 4, paragraph 4.2 “Displaying Material Properties”, in particular see FIG. 4.1 page 25.

It is believed that, while not wanting to be limited by theory, that the ultrasonic energy improves the rehydration and softening of the soil and hence makes it easier to clean. It is believed to do this by increasing the penetration rate of the cleaning formulation into the soil. The ultrasonic waves, plus ultrasonic cleaning composition, also are thought, while not wanting to be limited by theory, to help remove the softened soil by breaking the adhesive bonds between the soil and substrate.

By using this composition with a source of ultrasonic energy, stains or tough soils can be removed without the use of excessive force, rubbing, pressure or other manipulation which causes wear and tear on the stained material or surface. In doing so, the user does not need to impart such manual energy to remove the stain, thereby adding to the convenience of the user. The invention also encompasses processes by which such stains or soils are removed, either from localized regions or from the entire article to be cleaned.

It is preferred that these ultrasonic cleaning products further comprise instructions for using the product. One preferred set of instructions comprises the steps of
(i) applying an effective amount of the cleaning composition to the surface;
(ii) imparting ultrasonic waves to the surface using the device; and
(iii) optionally, rinsing the surface with an aqueous solution.

Another, preferred set of instructions comprise the steps of:
(i) using the device to apply an effective amount of the cleaning composition to the surface concurrently and coterminous with the cleaning head;
(ii) moving the cleaning head over and maintain contact thereto the surface and
(iii) optionally, rinsing the surface with an aqueous solution.

In one aspect of this it is preferred that steps (i) and (ii) are conducted simultaneously using a device that permits controlled dispensing of the liquid cleaning composition to the stain while concurrently imparting ultrasonic waves thereto.

In another aspect of this embodiment wherein the instructions for use direct the consumer to apply the cleaning composition to the one or more surfaces prior to and/or during applying ultrasonic energy to the one or more surfaces.

The acoustic system in the present invention is preferably made from a piezo ceramic element or elements, typically called PZTs, along with an acoustic amplifier, typically called an acoustic horn or acoustic transducer or sonotrode. The entire acoustic system is designed to operate at a specific frequency and power and deliver a predetermined amplitude at the end or tip of the sonotrode. The combination of the sonotrode design, amplitude, frequency and power dictates the cleaning efficacy. Further, not all of the parameters are independently chosen.

With regards to the design of the sonotrode, we have found that the are several shapes that provide improved cleaning benefits. One specific embodiment is a “chissel” design, where the sonotrode is tapered at the end which will contact the stain to be removed. Typically, the width of the sonotrode is 0.05 to 5 mm and the length is 10 to 50 mm. Further, we have found that cleaning is improved when the sonotrode is designed to deliver equal amplitude across the sonotrode blade. However, there are other applications where there may be advantages to have a higher localized amplitude. In the specific embodiment, we have found that a sonotrode blade in a “chisel” shape running at 50 kHz, 30 Watts and 40 microns provides significant cleaning benefits.

In addition, we have found sonotrodes designed in a “disc” or round shape which deliver significant cleaning benefits. This sonotrode design typically has a disc radius of from 10 to about 100 mm. Further, the sonotrode may present a more 3 dimensional appearance to the stain to be cleaned. The sonotrode may be in the shape of a hemisphere or may be disc shaped with undulations or dimples on the surface. In another embodiment, the sonotrode can be rectangular, oval, triangular shaped. Because of ergonomic considerations, it is preferred that the sonotrode have rounded edges. Each of these designs offers unique cleaning opportunities. In addition, the mass of the sonotrode is important to achieve the desired cleaning benefit. We have found that the sonotrode must have a mass between 20 and 500 grams.

Further, the sonotrode material must be chosen to have the desired acoustic properties and also be compatible with the chemistry being used in the cleaning application. The preferred materials are titanium and steel, preferably hardened steel. Less preferred, but acceptable for cleaners which are substantially free from bleaches and alkalinity is aluminum.

The acoustic system and in particular the sonotrode may be encased, surrounded, or in close proximity to adjunct materials to aid in the cleaning process. These include, but are not limited to, sponges, scouring pads, steel wool pads, high friction non-wovens, and absorbent natural and synthetic materials. These adjunct materials can help cleaning by removing the soils and stains that are loosened by the ultrasonic plus chemistry, and/or they can act to absorb residual stains and/or hold the cleaning solution in close contact with the stain or soil which is in contact with the ultrasonic energy. Optionally, these adjunct pads can be removable and/or disposable.

In an aspect of the present invention one suitable ultrasonic wave generating source comprises a housing, the housing comprises a griping means, more preferably the griping means is at the proximal end of the housing; a cleaning head adapted to rest on and be moved over surface to be cleaned, (or alternatively, the cleaning head is adapted to be just above the surface to be cleaned), more preferably the cleaning head is at the distal end of the housing; wherein the cleaning head is adapted to be removably mounted to the housing; a transducer means mounted in the housing for oscillating the cleaning head at an ultrasonic frequency; and a power supply means for supplying direct current to the transducer means, wherein the power supply means is associated with the device.

In another aspect of the present invention one suitable ultrasonic wave generating source comprises a first housing, the first housing comprising a griping means, more preferably the griping means is at the proximal end of the first housing; a cleaning head adapted to rest on and be moved over surface to be cleaned, more preferably the cleaning head is at the distal end of the first housing (or alternatively, the cleaning head is adapted to be just above the surface to be cleaned) and the cleaning head is adapted to be removably mounted to the first housing; a second housing, wherein the first housing is associated with the second housing and the second housing comprises a transducer means mounted in the second housing for oscillating the cleaning head at an ultrasonic frequency; and a power supply means for supplying direct current to the transducer means, wherein the power supply means is associated with the device, more preferably the power supply means is mounted in the second housing.

In another embodiment of this aspect of the present invention the ultrasonic wave generating source comprises at least one, more preferably at least two, solution storage means associated with the source, and the solution storage means contains at least one, more preferably at least two, cleaning composition suitable for cleaning the surface; and at least one, more preferably at least two, dispensing means mounted in the housing for supplying the at least one cleaning composition from the at least one solution storage means to the surface prior to or at the same time as the surface is contacted by the cleaning head. In another embodiment of this aspect of the present invention it is preferred that the solution storage means is adapted to be removably mounted to the housing. In another embodiment of this aspect of the present invention it is preferred that the solution storage means is mounted in the housing. In another embodiment of this aspect of the present invention the solution storage means can be either in the first housing, the second housing or both, with the corresponding dispensing means mounted in the first housing. One advantage of having two or more storage means is that incompatible cleaning ingredients, such as bleach and perfumes, which would ordinarily not be possible to combine in a cleaning composition without the loss of cleaning activity, can be put in different storage means. This allows the compositions to gain the cleaning benefits of these incompatible ingredients as they only come into contact with one another either just before dispensing or when the are applied to the surface. This means that any loss in cleaning potential would be minimized.

Indeed, the implement preferably further comprises a reservoir containing the cleaning solution. This reservoir may advantageously be removable or refillable, for example as a cartridge. The implement and one or more cartridges comprising cleaning solution may be provided as a kit. In a preferred embodiment, the active part is vibrating when the cleaning solution is delivered from the reservoir.

Preferably, the first housing is stored in the second housing while not in use. While in use the first housing is used to clean the surface while the second housing stores and supplies the cleaning composition(s), power and ultrasonic energy to the first housing to clean the surface. Alternatively, in another embodiment of this aspect of the present invention the second housing only supplies power, either DC current from a battery, or from the mains via an inverter/transformer.

In another embodiment of this aspect of the present invention the ultrasonic wave generating source is powered by any conventional power source, such as mains power, photovoltaic, “solar” cells, dynamos, rechargeable batteries, disposable batteries or combinations thereof, with rechargeable battery or rechargeable batteries being preferred. If mains are used, then the current, and voltage is converted via conventional methods, such as inverters, step down transformers, etc., to voltages, and currents suitable to deliver the ultrasonic wave of sufficient frequency and power. Likewise, single batteries, or combinations of batteries in series or parallel, can be used to deliver the ultrasonic wave of sufficient frequency and power. Combinations of, mains power and battery(s), could be used, with the possibility that the battery(s) recharge while the mains provides the source of power for the ultrasonic wave.

In one embodiment of this aspect of the present invention, the ultrasonic wave generating source has a power supply, in the form of a rechargeable battery, or batteries. The battery, or batteries, can be either recharged by removing them from the device and directly connecting them to the mains power supply, or to a battery recharger which is connected to the mains power supply. Alternatively, a “recharging station”, such as a cradle or dock, which is connected to the mains power is supply, is used to recharge the battery, or batteries. The ultrasonic wave generating source is placed in the “recharging station” when not in use, to maintain charge in the battery, or batteries, or to recharge them as needed. Alternatively, the ultrasonic wave generating source could itself be directly connected to the mains power supply for recharging the battery or batteries, without removal of the battery or batteries from the ultrasonic wave generating source.

In another embodiment of this aspect of the present invention the ultrasonic wave generating source is adapted to function while partially immersed in an aqueous environment, more preferably the source is adapted to function while totally immersed in an aqueous environment. In another embodiment of this aspect of the present invention the ultrasonic wave generating source is water resistant, more preferably water proof. That is, when the device is made for cleaning in aqueous environment, such as washing dishes, pots etc., the device can be either partially or totally immersed without damage to the device or harm to the user. While devices that would be only used for cleaning surfaces, such as floors, couches, clothes, tables, etc., would not need to adapted to function while partially immersed in an aqueous environment, more preferably the device is adapted to function while totally immersed in an aqueous environment, it is highly preferred that the devices at least be adapted to function while partially immersed in an aqueous environment.

In one embodiment of this aspect of the present invention the ultrasonic cleaning device has a weight lower than 1 kg (2.2 lbs), more preferably lower than 0.6 kg (1.3 lb). A length lower than 50 cm (20 inches), more preferably lower than 30 cm (12 inches). Its diameter is lower than 10 cm (4 inches), preferably lower than 5 cm (2 inches). It includes a product reservoir lower than 500 ml, more preferable lower than 200 ml.

Another possible ultrasonic generation device is that of copending application U.S. 60/180,629, Attorneys docket number 7341, filed on Nov. 16, 1998.

It is also preferred that the device provides a power output per unit of surface area of the cleaning head of at least about 5 watts/cm², more preferably at least about 10 watts/cm², even more preferably at least about 25 watts/cm², even more preferably still at least about 50 watts/cm².

Typical soil treatment times range from about 1 second to about 10 minutes, more typically from about 10 seconds to about 5 minutes, more typically from about 20 seconds to 2 minutes, even more typically from about 30 seconds to about 1 minute, although treatment times will vary with the severity of the stain or toughness of the soil, and the surface from which the soil/stain is being removed. The ultrasonic source device can be a vibrational ultrasonic generator, a torsional ultrasonic wave generator, or an axial ultrasonic generator in that it is the shock waves generated by these ultrasonic sources that does the actual cleaning or loosening of the stain on the textile regardless of the mechanism by which the ultrasonic shock waves are generated. The ultrasonic wave generating device can be battery operated or a plug-in type.

A cleaning kit may be provided comprising a device, article of manufacture or implement according to the invention. In one embodiment of this aspect of the present invention the cleaning kit is a fabric cleaning kit, and the composition contained in the article of manufacture is a pre-treating composition. In one embodiment of this aspect of the present invention the cleaning composition is a laundry detergent composition, such as a granular or HDL (heavy duty liquid) compositions. The cleaning composition may optionally be in the form of a granule, tablet or a liquid. In a further embodiment of this aspect of the present invention the fabric cleaning composition kit may additionally contain a fabric softener, such as a rinse added fabric softener, fabric softener which is used in a clothes dryer, such as dryer added sheets, or mixtures thereof. In another embodiment of this aspect of the present invention the fabric cleaning composition kit may be used on a variety of surfaces such as carpets, apparel, and upholstery, of a variety of materials, including, but not limited to wool, nylon, silk, rayon, etc.

In another embodiment of this aspect of the present invention the cleaning kit is a tableware cleaning kit, and the composition contained in the article of manufacture is a pre-treating composition. In one embodiment of this aspect of the present invention the cleaning composition is a automatic dishwashing detergent composition, such as a granular, gel or liquid ADW composition. In a further embodiment of this aspect of the present invention the tableware cleaning composition kit may additionally contain a rinse aid. In another embodiment of this aspect of the present invention the cleaning composition is a hand dishwashing detergent composition, such as a gel or liquid LDL composition. Regardless of whether the cleaning composition is an ADW or LDL the cleaning composition may optionally be in the form of a granule, tablet, liquid, liquid-gel or a gel.

Cleaning Solutions

The cleaning solutions or compositions used herein will typically contain suitable conventional cleaning agents, such as, builders, surfactants, enzymes, bleach activators, bleach boosters, bleach catatlysts, bleaches, alkalinity sources, colorants, perfume, lime soap dispersants, polymeric dye transfer inhibiting agents, antibacterial agent, crystal growth inhibitors, photobleaches, heavy metal ion sequestrants, anti-tarnishing agents, anti-microbial agents, anti-oxidants, anti-redeposition agents, soil release polymers, electrolytes, pH modifiers, thickeners, abrasives, divalent metal ions, metal ion salts, enzyme stabilizers, corrosion inhibitors, diamines, suds stabilizing polymers, solvents, process aids, fabric softening agents, optical brighteners, hydrotropes and mixtures thereof.

Surfactants:

The compositions according to the present invention may comprise surfactants preferably selected from: anionic surfactants, preferably selected from the group of alkyl alkoxylated sulfates, alkyl sulfates, alkyl disulfates, and/or linear alkyl benzenesulfonate surfactants; cationic surfactants, preferably selected from quaternary ammonium surfactants; nonionic surfactants, preferably alkyl ethoxylates, alkyl polyglucosides, polyhydroxy fatty acid amides, and/or amine or amine oxide surfactants; amphoteric surfactants, preferably selected from betaines and/or polycarboxylates (for example polyglycinates); and zwiterionic surfactants.

A wide range of these surfactants can be used in the cleaning compositions of the present invention. A typical listing of anionic, nonionic, ampholytic and zwitterionic classes, and species of these surfactants, is given in U.S. Pat. No. 3,664,961 issued to Norris on May 23, 1972. Amphoteric surfactants are also described in detail in “Amphoteric Surfactants, Second Edition”, E. G. Lomax, Editor (published 1996, by Marcel Dekker, Inc.). Suitable surfactants can be found in U.S. patent application Ser. Nos. 60/032,035 (Docket No. 6401P), 60/031,845 (Docket No. 6402P), 60/031,916 (Docket No. 6403P), 60/031,917 (Docket No. 6404P), 60/031,761 (Docket No. 6405P), 60/031,762 (Docket No. 6406P), 60/031,844 (Docket No. 6409P), No. 60/061,971, Attorney docket No 6881P Oct. 14, 1997, No. 60/061,975, Attorney docket No 6882P Oct. 14, 1997, No. 60/062,086, Attorney docket No 6883P Oct. 14, 1997, No. 60/061,916, Attorney docket No 6884P Oct. 14, 1997, No. 60/061,970, Attorney docket No 6885P Oct. 14, 1997, No. 60/062,407, Attorney docket No 6886P Oct. 14, 1997, 60/053,319 filed on Jul. 21, 1997 (Docket No. 6766P), 60/053,318 filed on Jul. 21, 1997 (Docket No. 6767P), 60/053,321 filed on Jul. 21, 1997 (Docket No. 6768P), 60/053,209 filed on Jul. 21, 1997 (Docket No. 6769P), 60/053,328 filed on Jul. 21, 1997 (Docket No. 6770P), 60/053,186 filed on Jul. 21, 1997 (Docket No. 6771P), 60/053,437 filed on Aug. 8, 1997 (Docket No. 6796P), 60/105,017 filed on Oct. 20, 1998 (Docket No. 7303P), and 60/104,962 filed on Oct. 20, 1998 (Docket No. 7304P) all of which are incorporated herein by reference.

The compositions of the present invention preferably comprise from about 0.01% to about 55%, more preferably from about 0.1% to about 45%, more preferably from about 0.25% to about 30%, more preferably from about 0.5% to about 20%, by weight of surfactants. Selected surfactants are further identified as follows.

(1) Anionic Surfactants:

Nonlimiting examples of anionic surfactants useful herein, typically at levels from about 0.1% to about 50%, by weight, include the conventional C₁₁-C₁₈ alkyl benzene sulfonates (“LAS”) and primary, branched-chain and random C₁₀-C₂₀ alkyl sulfates (“AS”), the C₁₀-C₁₈ secondary (2,3) alkyl sulfates of the formula CH₃(CH₂)ₓ(CHOSO₃⁻M⁺) CH₃ and CH₃ (CH₂)_{y}(CHOSO₃⁻M⁺) CH₂CH₃ where x and (y+1) are integers of at least about 7, preferably at least about 9, and M is a water-solubilizing cation, especially sodium, unsaturated sulfates such as oleyl sulfate, the C₁₀-C₁₈ alpha-sulfonated fatty acid esters, the C₁₀C₁₈ sulfated alkyl polyglycosides, the C₁₀-C₁₈ alkyl alkoxy sulfates (“AExS”; especially EO 1-7 ethoxy sulfates), and C₁₀-C₁₈ alkyl alkoxy carboxylates (especially the EO 1-5 ethoxycarboxylates). ₁₀-C₂₀ conventional soaps may also be used. If high sudsing is desired, the branched-chain C₁₀-C₁₆ soaps may be used. Other conventional useful anionic co-surfactants are listed in standard texts.

Other suitable anionic surfactants that can be used are alkyl ester sulfonate surfactants including linear esters of C₈-C₂₀ carboxylic acids (i.e., fatty acids) which are sulfonated with gaseous SO₃ according to “The Journal of the American Oil Chemists Society”, 52 (1975), pp. 323-329. Suitable starting materials would include natural fatty substances as derived from tallow, palm oil, etc.

Another type of useful surfactants are the so-called dianionics. These are surfactants which have at least two anionic groups present on the surfactant molecule. Some suitable dianionic surfactants are further described in copending U.S. Ser. No. 60/020,503 (Docket No. 6160P), 60/020,772 (Docket No. 6161P), 60/020,928 (Docket No. 6158P), 60/020,832 (Docket No. 6159P) and 60/020,773 (Docket No. 6162P) all filed on Jun. 28, 1996, and 60/023,539 (Docket No. 6192P), 60/023,493 (Docket No. 6194P), 60/023,540 (Docket No. 6193P) and 60/023,527 (Docket No. 6195P) filed on Aug. 8, 1996, the disclosures of which are incorporated herein by reference.

Additionally and preferably, the surfactant may be a branched alkyl sulfate, branched alkyl alkoxylate, or branched alkyl alkoxylate sulfate. These surfactants are further described in No. 60/061,971, Attorney docket No 6881P Oct. 14, 1997, No. 60/061,975, Attorney docket No 6882P Oct. 14, 1997, No. 60/062,086, Attorney docket No 6883P Oct. 14, 1997, No. 60/061,916, Attorney docket No 6884P Oct. 14, 1997, No. 60/061,970, Attorney docket No 6885P Oct. 14, 1997, No. 60/062,407, Attorney docket No 6886P Oct. 14, 1997. Other suitable mid-chain branched surfactants can be found in U.S. patent application Ser. Nos. 60/032,035 (Docket No. 6401P), 60/031,845 (Docket No. 6402P), 60/031,916 (Docket No. 6403P), 60/031,917 (Docket No. 6404P), 60/031,761 (Docket No. 6405P), 60/031,762 (Docket No. 6406P) and 60/031,844 (Docket No. 6409P). Mixtures of these branched surfactants with conventional linear surfactants are also suitable for use in the present compositions.

Additionally, the surfactant may be a modified alkylbenzene sulfonate surfactants, or MLAS. Suitable MLAS surfactants can be found in U.S. patent application Ser. Nos. 60/053,319 filed on Jul. 21, 1997 (Docket No. 6766P), 60/053,318 filed on Jul. 21, 1997 (Docket No. 6767P), 60/053,321 filed on Jul. 21, 1997 (Docket No. 6768P), 60/053,209 filed on Jul. 21, 1997 (Docket No. 6769P), 60/053,328 filed on Jul. 21, 1997 (Docket No. 6770P), 60/053,186 filed on Jul. 21, 1997 (Docket No. 6771P), 60/053,437 filed on Aug. 8, 1997 (Docket No. 6796P), 60/105,017 filed on Oct. 20, 1998 (Docket No. 7303P), and 60/104,962 filed on Oct. 20, 1998 (Docket No. 7304P). Mixtures of these branched surfactants with conventional linear surfactants are also suitable for use in the present compositions.

When included therein, the laundry detergent compositions of the present invention typically comprise from about 0.1% to about 50%, preferably from about 1% to about 40% by weight of an anionic surfactant.

(2) Nonionic Surfactants:

Nonlimiting examples of nonionic surfactants useful herein typically at levels from about 0.1% to about 50%, by weight include the alkoxylated alcohols (AE's) and alkyl phenols, polyhydroxy fatty acid amides (PFAA's), alkyl polyglycosides (APG's), C₁₀-C₁₈ glycerol ethers, and the like.

Examples of commercially available nonionic surfactants of this type include: Tergitol™ 15-S-9 (the condensation product of C₁₁-C₁₅ linear alcohol with 9 moles ethylene oxide) and Tergitol™ 24-L-6 NMW (the condensation product of C₁₂-C₁₄ primary alcohol with 6 moles ethylene oxide with a narrow molecular weight distribution), both marketed by Union Carbide Corporation; Neodol™ 45-9 (the condensation product of C₁₄-C₁₅ linear alcohol with 9 moles of ethylene oxide), Neodol™ 23-3 (the condensation product of C₁₂-C₁₃ linear alcohol with 3 moles of ethylene oxide), Neodol™ 45-7 (the condensation product of C₁₄-C₁₅ linear alcohol with 7 moles of ethylene oxide) and Neodol™ 45-5 (the condensation product of C₁₄-C₁₅ linear alcohol with 5 moles of ethylene oxide) marketed by Shell Chemical Company; Kyro™ EOB (the condensation product of C₁₃-C₁₅ alcohol with 9 moles ethylene oxide), marketed by The Procter & Gamble Company; and Genapol LA 030 or 050 (the condensation product of C₁₂-C₁₄ alcohol with 3 or 5 moles of ethylene oxide) marketed by Hoechst. The preferred range of HLB in these AE nonionic surfactants is from 8-17 and most preferred from 8-14. Condensates with propylene oxide and butylene oxides may also be used.

Another class of preferred nonionic surfactants for use herein are the polyhydroxy fatty acid amide surfactants of the formula. 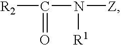
wherein R¹ is H, or C₁₋₄ hydrocarbyl, 2-hydroxy ethyl, 2-hydroxy propyl or a mixture thereof, R² is C₅₋₃₁ hydrocarbyl, and Z is a polyhydroxyhydrocarbyl having a linear hydrocarbyl chain with at least 3 hydroxyls directly connected to the chain, or an alkoxylated derivative thereof. Typical examples include the C₁₂-C₁₈ and C₁₂-C₁₄ N-methylglucamides. See U.S. Pat. Nos. 5,194,639 and 5,298,636. N-alkoxy polyhydroxy fatty acid amides can also be used; see U.S. Pat. No. 5,489,393.

Also useful as a nonionic surfactant in the present invention are the alkylpolysaccharides such as those disclosed in U.S. Pat. No. 4,565,647, Llenado, issued Jan. 21, 1986.

Preferred alkylpolyglycosides have the formula
R²O(CₙH₂ₙO)ₜ(glycosyl)ₓ
wherein R² is selected from the group consisting of alkyl, alkylphenyl, hydroxyalkyl, hydroxyalkylphenyl, and mixtures thereof in which the alkyl groups contain from about 10 to about 18, preferably from about 12 to about 14, carbon atoms; n is 2 or 3, preferably 2; t is from 0 to about 10, preferably 0; and x is from about 1.3 to about 10, preferably from about 1.3 to about 3, most preferably from about 1.3 to about 2.7. The glycosyl is preferably derived from glucose. To prepare these compounds, the alcohol or alkylpolyethoxy alcohol is formed first and then reacted with glucose, or a source of glucose, to form the glucoside (attachment at the 1-position). The additional glycosyl units can then be attached between their 1-position and the preceding glycosyl units 2-, 3-, 4- and/or 6-position, preferably predominately the 2-position. Compounds of this type and their use in detergent are disclosed in EP-B 0 070 077, 0 075 996 and 0 094 118.

Polyethylene, polypropylene, and polybutylene oxide condensates of alkyl phenols are also suitable for use as the nonionic surfactant of the surfactant systems of the present invention, with the polyethylene oxide condensates being preferred. These compounds include the condensation products of alkyl phenols having an alkyl group containing from about 6 to about 14 carbon atoms, preferably from about 8 to about 14 carbon atoms, in either a straight-chain or branched-chain configuration with the alkylene oxide. In a preferred embodiment, the ethylene oxide is present in an amount equal to from about 2 to about 25 moles, more preferably from about 3 to about 15 moles, of ethylene oxide per mole of alkyl phenol. Commercially available nonionic surfactants of this type include Igepal™ CO-630, marketed by the GAF Corporation; and Triton™ X-45, X-114, X-100 and X-102, all marketed by the Rohm & Haas Company. These surfactants are commonly referred to as alkylphenol alkoxylates (e.g., alkyl phenol ethoxylates).

The condensation products of ethylene oxide with a hydrophobic base formed by the condensation of propylene oxide with propylene glycol are also suitable for use as the additional nonionic surfactant in the present invention. The hydrophobic portion of these compounds will preferably have a molecular weight of from about 1500 to about 1800 and will exhibit water insolubility. The addition of polyoxyethylene moieties to this hydrophobic portion tends to increase the water solubility of the molecule as a whole, and the liquid character of the product is retained up to the point where the polyoxyethylene content is about 50% of the total weight of the condensation product, which corresponds to condensation with up to about 40 moles of ethylene oxide. Examples of compounds of this type include certain of the commercially-available Pluronic™ surfactants, marketed by BASF.

Also suitable for use as the nonionic surfactant of the nonionic surfactant system of the present invention, are the condensation products of ethylene oxide with the product resulting from the reaction of propylene oxide and ethylenediamine. The hydrophobic moiety of these products consists of the reaction product of ethylenediamine and excess propylene oxide, and generally has a molecular weight of from about 2500 to about 3000. This hydrophobic moiety is condensed with ethylene oxide to the extent that the condensation product contains from about 40% to about 80% by weight of polyoxyethylene and has a molecular weight of from about 5,000 to about 11,000. Examples of this type of nonionic surfactant include certain of the commercially available Tetronic™ compounds, marketed by BASF.

In general, bleach-stable nonionic co-surfactants are preferred These nonionic co-surfactants when present, are included at levels of from about 0.1% to about 15% of the composition. The nonionic co-surfactant may be a low cloud point nonionic surfactant, a high cloud point nonionic surfactant or mixtures thereof. One preferred of the present invention, includes a low cloud point nonionic csurfactant, and/or a high cloud point nonionic surfactant in addition to the surfactant of the present invention. Nonionic surfactants generally are well known, being described in more detail in Kirk Othmer's Encyclopedia of Chemical Technology, 3rd Ed., Vol. 22, pp. 360-379, “Surfactants and Detersive Systems”, incorporated by reference herein.

“Cloud point”, as used herein, is a well known property of nonionic surfactants which is the result of the surfactant becoming less soluble with increasing temperature, the temperature at which the appearance of a second phase is observable is referred to as the “cloud point” (See Kirk Othmer, pp. 360-362, hereinbefore).

As used herein, a “low cloud point” nonionic surfactant is defined as a nonionic surfactant system ingredient having a cloud point of less than 30° C., preferably less than about 20° C., and most preferably less than about 10° C. Typical low cloud point nonionic surfactants include nonionic alkoxylated surfactants, especially ethoxylates derived from primary alcohol, and polyoxypropylene/polyoxyethylene/polyoxypropylene (PO/EO/PO) reverse block polymers. Also, such low cloud point nonionic surfactants include, for example, ethoxylated-propoxylated alcohol (e.g., Olin Corporation's Poly-Tergent® SLF18) and epoxy-capped poly(oxyalkylated) alcohols (e.g., Olin Corporation's Poly-Tergent® SLF18B series of nonionics, as described, for example, in WO 94/22800, published Oct. 13, 1994 by Olin Corporation).

Nonionic surfactants can optionally contain propylene oxide in an amount up to about 15% by weight. Other preferred nonionic co-surfactants can be prepared by the processes described in U.S. Pat. No. 4,223,163, issued Sep. 16, 1980, Builloty, incorporated herein by reference.

Low cloud point nonionic surfactants additionally comprise a polyoxyethylene, polyoxypropylene block polymeric compound. Block polyoxyethylene-polyoxypropylene polymeric compounds include those based on ethylene glycol, propylene glycol, glycerol, trimethylolpropane and ethylenediamine as initiator reactive hydrogen compound. Certain of the block polymer surfactant compounds designated PLURONIC®, REVERSED PLURONIC®, and TETRONIC® by the BASF-Wyandotte Corp., Wyandotte, Mich., are suitable in ADD compositions of the invention. Preferred examples include REVERSED PLURONIC® 25R2 and TETRONIC® 702, Such surfactants are typically useful herein as low cloud point nonionic surfactants.

As used herein, a “high cloud point” nonionic surfactant is defined as a nonionic surfactant system ingredient having a cloud point of greater than 40° C., preferably greater than about 50° C., and more preferably greater than about 60° C. Preferably the nonionic surfactant system comprises an ethoxylated surfactant derived from the reaction of a monohydroxy alcohol or alkylphenol containing from about 8 to about 20 carbon atoms, with from about 6 to about 15 moles of ethylene oxide per mole of alcohol or alkyl phenol on an average basis. Such high cloud point nonionic surfactants include, for example, Tergitol 15S9 (supplied by Union Carbide), Rhodasurf TMD 8.5 (supplied by Rhone Poulenc), and Neodol 91-8 (supplied by Shell).

It is also preferred for purposes of the present invention that the high cloud point nonionic surfactant further have a hydrophile-lipophile balance (“HLB”; see Kirk Othmer hereinbefore) value within the range of from about 9 to about 15, preferably 11 to 15. Such materials include, for example, Tergitol 15S9 (supplied by Union Carbide), Rhodasurf TMD 8.5 (supplied by Rhone Poulenc), and Neodol 91-8 (supplied by Shell).

Another preferred high cloud point nonionic surfactant is derived from a straight or preferably branched chain or secondary fatty alcohol containing from about 6 to about 20 carbon atoms (C₆-C₂₀ alcohol), including secondary alcohols and branched chain primary alcohols. Preferably, high cloud point nonionic surfactants are branched or secondary alcohol ethoxylates, more preferably mixed C9/11 or C11/15 branched alcohol ethoxylates, condensed with an average of from about 6 to about 15 moles, preferably from about 6 to about 12 moles, and most preferably from about 6 to about 9 moles of ethylene oxide per mole of alcohol. Preferably the ethoxylated nonionic surfactant so derived has a narrow ethoxylate distribution relative to the average.

When the surfactants are a mixture of low cloud point nonionics and high cloud point nonionics it is preferred that the mixture is combined in a weight ratio preferably within the range of from about 10:1 to about 1:10.

(3) Cationic Surfactants:

Nonlimiting examples of cationic surfactants useful herein typically at levels from about 0.1% to about 50%, by weight include the choline ester-type quats and alkoxylated quaternary ammonium (AQA) surfactant compounds, and the like. Most preferred for aqueous liquid compositions herein are soluble cationic surfactants which do not readily hydrolyze in the product.

Cationic surfactants useful as a component of the surfactant system is a cationic choline ester-type quat surfactant which are preferably water dispersible compounds having surfactant properties and comprise at least one ester (i.e.—COO—) linkage and at least one cationically charged group. Suitable cationic ester surfactants, including choline ester surfactants, have for example been disclosed in U.S. Pat. Nos. 4,228,042, 4,239,660 and 4,260,529.

Cationic ester surfactants include those having the formula: 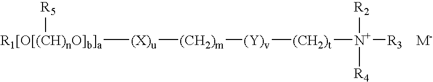
wherein R₁ is a C₅-C₃₁ linear or branched alkyl, alkenyl or alkaryl chain or M⁻.N⁺(R₆R₇R₈)(CH₂)ₛ; X and Y, independently, are selected from the group consisting of COO, OCO, O, CO, OCOO, CONH, NHCO, OCONH and NHCOO wherein at least one of X or Y is a COO, OCO, OCOO, OCONH or NHCOO group; R₂, R₃, R₄, R₆, R₇ and R₈ are independently selected from the group consisting of alkyl, alkenyl, hydroxyalkyl, hydroxyalkenyl and alkaryl groups having from 1 to 4 carbon atoms; and R₅ is independently H or a C₁-C₃ alkyl group; wherein the values of m, n, s and t independently lie in the range of from 0 to 8, the value of b lies in the range from 0 to 20, and the values of a, u and v independently are either 0 or 1 with the proviso that at least one of u or v must be 1; and wherein M is a counter anion.

Preferably R₂, R₃ and R₄ are independently selected from CH₃ and —CH₂CH₂OH.

Preferably M is selected from the group consisting of halide, methyl sulfate, sulfate, and nitrate, more preferably methyl sulfate, chloride, bromide or iodide.

Preferred water dispersible cationic ester surfactants are the choline esters having the formula: 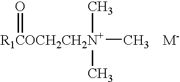
wherein R₁ is a C₁₁-C₁₉ linear or branched alkyl chain.

Particularly preferred choline esters of this type include the stearoyl choline ester quaternary methylammonium halides (R¹═C₁₇ alkyl), palmitoyl choline ester quaternary methylammonium halides (R¹═C₁₅ alkyl), myristoyl choline ester quaternary methylammonium halides (R¹═C₁₃ alkyl), lauroyl choline ester quaternary methylammonium halides (R¹═C₁₁ alkyl), cocoyl choline ester quaternary methylammonium halides (R¹═C₁₁-C₁₃ alkyl), tallowyl choline ester quaternary methylammonium halides (R¹═C₁₅-C₁₇ alkyl), and any mixtures thereof.

The particularly preferred choline esters, given above, may be prepared by the direct esterification of a fatty acid of the desired chain length with dimethylaminoethanol, in the presence of an acid catalyst. The reaction product is then quaternized with a methyl halide, preferably in the presence of a solvent such as ethanol, propylene glycol or preferably a fatty alcohol ethoxylate such as C₁₀-C₁₈ fatty alcohol ethoxylate having a degree of ethoxylation of from 3 to 50 ethoxy groups per mole forming the desired cationic material. They may also be prepared by the direct esterification of a long chain fatty acid of the desired chain length together with 2-haloethanol, in the presence of an acid catalyst material. The reaction product is then quaternized with trimethylamine, forming the desired cationic material.

In a preferred aspect these cationic ester surfactant are hydrolysable under the conditions of a laundry wash method.

Cationic surfactants useful herein also include alkoxylated quaternary ammonium (AQA) surfactant compounds (referred to hereinafter as “AQA compounds”) having the formula: 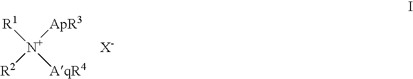
wherein R¹ is an alkyl or alkenyl moiety containing from about 8 to about 18 carbon atoms, preferably 10 to about 16 carbon atoms, most preferably from about 10 to about 14 carbon atoms; R² is an alkyl group containing from one to three carbon atoms, preferably methyl; R³ and R⁴ can vary independently and are selected from hydrogen (preferred), methyl and ethyl; X⁻ is an anion such as chloride, bromide, methylsulfate, sulfate, or the like, sufficient to provide electrical neutrality. A and A′ can vary independently and are each selected from C₁-C₄ alkoxy, especially ethoxy (i.e., —CH₂CH₂O—), propoxy, butoxy and mixed ethoxy/propoxy; p is from 0 to about 30, preferably 1 to about 4 and q is from 0 to about 30, preferably 1 to about 4, and most preferably to about 4; preferably both p and q are 1. See also: EP 2,084, published May 30, 1979, by The Procter & Gamble Company, which describes cationic surfactants of this type which are also useful herein.

The levels of the AQA surfactants used to prepare finished laundry detergent compositions typically range from about 0.1% to about 5%, preferably from about 0.45% to about 2.5%, by weight.

Other Surfactants—

Amphoteric or zwitterionic detersive surfactants when present are usually useful at levels in the range from about 0.1% to about 20% by weight of the detergent composition. Often levels will be limited to about 5% or less, especially when the amphoteric is costly.

Suitable amphoteric surfactants include the amine oxides corresponding to the formula:
R R′R″N→O
wherein R is a primary alkyl group containing 6-24 carbons, preferably 10-18 carbons, and wherein R′ and R″ are, each, independently, an alkyl group containing 1 to 6 carbon atoms. The arrow in the formula is a conventional representation of a semi-polar bond.

Amine oxides are semi-polar surfactants and include water-soluble amine oxides containing one alkyl moiety of from about 10 to about 18 carbon atoms and 2 moieties selected from the group consisting of alkyl groups and hydroxyalkyl groups containing from about 1 to about 3 carbon atoms; water-soluble phosphine oxides containing one alkyl moiety of from about 10 to about 18 carbon atoms and 2 moieties selected from the group consisting of alkyl groups and hydroxyalkyl groups containing from about 1 to about 3 carbon atoms; and water-soluble sulfoxides containing one alkyl moiety of from about 10 to about 18 carbon atoms and a moiety selected from the group consisting of alkyl and hydroxyalkyl moieties of from about 1 to about 3 carbon atoms.

Preferred amine oxide surfactants having the formula 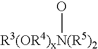
wherein R³ is an alkyl, hydroxyalkyl, or alkyl phenyl group or mixtures thereof containing from about 8 to about 22 carbon atoms; R⁴ is an alkylene or hydroxyalkylene group containing from about 2 to about 3 carbon atoms or mixtures thereof, x is from 0 to about 3; and each R⁵ is an alkyl or hydroxyalkyl group containing from about 1 to about 3 carbon atoms or a polyethylene oxide group containing from about 1 to about 3 ethylene oxide groups. The R⁵ groups can be attached to each other, e.g., through an oxygen or nitrogen atom, to form a ring structure. Exemplary, amine oxides are illustrated by C₁₂-₁₄ alkyldimethyl amine oxide, hexadecyl dimethylamine oxide, octadecylamine oxide and their hydrates, especially the dihydrates as disclosed in U.S. Pat. Nos. 5,075,501 and 5,071,594, incorporated herein by reference. Such amine oxides can be prepared by conventional synthetic methods, e.g., by the reaction of alkylethoxysulfates with dimethylamine followed by oxidation of the ethoxylated amine with hydrogen peroxide.

Highly preferred amine oxides useful herein are solutions at ambient temperature. Amine oxides suitable for use herein are made commercially by a number of suppliers, including Akzo Chemie, Ethyl Corp., and Procter & Gamble. See McCutcheon's compilation and Kirk-Othmer review article for alternate amine oxide manufacturers.

Other suitable amine oxided include compounds, such as hexadecylbis(2-hydroxyethyl)amine oxide, tallowbis(2-hydroxyethyl)amine oxide, stearylbis(2-hydroxyethyl)amine oxide and oleylbis(2-hydroxyethyl)amine oxide, dodecyldimethylamine oxide dihydrate.

These amine oxide surfactants in particular include C₁₀-C₁₈ alkyl dimethyl amine oxides and C₈-C₁₂ alkoxy ethyl dihydroxy ethyl amine oxides. Preferably the amine oxide is present in the composition in an effective amount, more preferably from about 0.1% to about 20%, even more preferably about 0.1% to about 15%, even more preferably still from about 0.5% to about 10%, by weight.

Some suitable zwitterionic surfactants which can be used herein comprise the betaine and betaine-like surfactants wherein the molecule contains both basic and acidic groups which form an inner salt giving the molecule both cationic and anionic hydrophilic groups over a broad range of pH values. Some common examples of these s are described in U.S. Pat. Nos. 2,082,275, 2,702,279 and 2,255,082, incorporated herein by reference. One of the preferred zwitterionic compounds have the formula 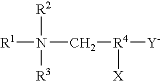
wherein R1 is an alkyl radical containing from 8 to 22 carbon atoms, R2 and R3 contain from 1 to 3 carbon atoms, R4 is an alkylene chain containing from 1 to 3 carbon atoms, X is selected from the group consisting of hydrogen and a hydroxyl radical, Y is selected from the group consisting of carboxyl and sulfonyl radicals and wherein the sum of R1, R2 and R3 radicals is from 14 to 24 carbon atoms.

Zwitterionic surfactants, as mentioned hereinbefore, contain both a cationic group and an anionic group and are in substantial electrical neutrality where the number of anionic charges and cationic charges on the surfactant molecule are substantially the same. Zwitterionics, which typically contain both a quaternary ammonium group and an anionic group selected from sulfonate and carboxylate groups are desirable since they maintain their amphoteric character over most of the pH range of interest for cleaning hard surfaces. The sulfonate group is the preferred anionic group.

Polymeric Suds Stabilizer—The compositions of the present invention may optionally contain a polymeric suds stabilizer. These polymeric suds stabilizers provide extended suds volume and suds duration without sacrificing the grease cutting ability of the liquid detergent compositions. These polymeric suds stabilizers are selected from:
i) homopolymers of (N,N-dialkylamino)alkyl acrylate esters having the formula: 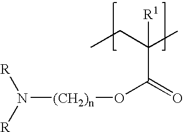
   wherein each R is independently hydrogen, C₁-C₈ alkyl, and mixtures thereof, R¹ is hydrogen, C₁-C₆ alkyl, and mixtures thereof, n is from 2 to about 6; and
ii) copolymers of (i) and 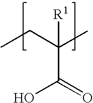
   wherein R¹ is hydrogen, C₁-C₆ alkyl, and mixtures thereof, provided that the ratio of (ii) to (i) is from about 2 to 1 to about 1 to 2; The molecular weight of the polymeric suds boosters, determined via conventional gel permeation chromatography, is from about 1,000 to about 2,000,000, preferably from about 5,000 to about 1,000,000, more preferably from about 10,000 to about 750,000, more preferably from about 20,000 to about 500,000, even more preferably from about 35,000 to about 200,000. The polymeric suds stabilizer can optionally be present in the form of a salt, either an inorganic or organic salt, for example the citrate, sulfate, or nitrate salt of (N,N-dimethylamino)alkyl acrylate ester.

One preferred polymeric suds stabilizer is (N,N-dimethylamino)alkyl acrylate esters, namely

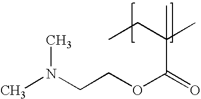

When present in the compositions, the polymeric suds booster may be present in the composition from about 0.01% to about 15%, preferably from about 0.05% to about 10%, more preferably from about 0.1% to about 5%, by weight.

Other suitable polymeric suds stabilizers, including protenacious suds stabilizers and zwitterionic suds stabilizers, can be found in PCT/US98/24853 filed Nov. 20, 1998 (Docket No. 6938), PCT/US98/24707 filed Nov. 20, 1998(Docket No. 6939), PCT/US98/24699 filed Nov. 20, 1998(Docket No. 6943), and PCT/US98/24852 filed Nov. 20, 1998(Docket No. 6944). Also suitable are the cationic copolymer stabilizers, which can be found in U.S. Pat. No. 4,454,060.

Enzymes—While in one aspect of the present invention, the compositions are substantially free from enzymes, in another aspect of the present invention it is within the scope of the present invention to incorporate enzymes. Suitable enzymes include enzymes selected from cellulases, hemicellulases, peroxidases, proteases, gluco-amylases, amylases, lipases, cutinases, pectinases, xylanases, reductases, oxidases, phenoloxidases, lipoxygenases, ligninases, pullulanases, tannases, pentosanases, malanases, β-glucanases, arabinosidases or mixtures thereof. A one possible combination is a detergent composition having a cocktail of conventional applicable enzymes like protease, amylase, lipase, cutinase and/or cellulase. Enzymes when present in the compositions, at from about 0.0001% to about 5% of active enzyme by weight of the detergent composition.

Proteolytic Enzyme—The proteolytic enzyme can be of animal, vegetable or microorganism (preferred) origin. The proteases for use in the detergent compositions herein include (but are not limited to) trypsin, subtilisin, chymotrypsin and elastase-type proteases. Preferred for use herein are subtilisin-type proteolytic enzymes. Particularly preferred is bacterial serine proteolytic enzyme obtained from Bacillus subtilis and/or Bacillus licheniformis.

Suitable proteolytic enzymes include Novo Industri A/S Alcalase® (preferred), Esperase®, Savinase® (Copenhagen, Denmark), Gist-brocades' Maxatase®, Maxacal® and Maxapem 15® (protein engineered Maxacal®) (Delft, Netherlands), and subtilisin BPN and BPN′ (preferred), which are commercially available. Preferred proteolytic enzymes are also modified bacterial serine proteases, such as those made by Genencor International, Inc. (San Francisco, Calif.) which are described in European Patent 251,446B, granted Dec. 28, 1994 (particularly pages 17, 24 and 98) and which are also called herein “Protease B”. U.S. Pat. No. 5,030,378, Venegas, issued Jul. 9, 1991, refers to a modified bacterial serine proteolytic enzyme (Genencor International) which is called “Protease A” herein (same as BPN′). In particular see columns 2 and 3 of U.S. Pat. No. 5,030,378 for a complete description, including amino sequence, of Protease A and its variants. Other proteases are sold under the tradenames: Primase, Durazym, Opticlean and Optimase. Preferred proteolytic enzymes, then, are selected from the group consisting of Alcalase® (Novo Industri A/S), BPN′, Protease A and Protease B (Genencor), and mixtures thereof. Protease B is most preferred.

Of particular interest for use herein are the proteases described in U.S. Pat. No. 5,470,733.

Also proteases described in our co-pending application U.S. Ser. No. 08/136,797 can be included in the detergent composition of the invention.

Another preferred protease, referred to as “Protease D” is a carbonyl hydrolase variant having an amino acid sequence not found in nature, which is derived from a precursor carbonyl hydrolase by substituting a different amino acid for a plurality of amino acid residues at a position in said carbonyl hydrolase equivalent to position +76, preferably also in combination with one or more amino acid residue positions equivalent to those selected from the group consisting of +99, +101, +103, +104, +107, +123, +27, +105, +109, +126, +128, +135, +156, +166, +195, +197, +204, +206, +210, +216, +217, +218, +222, +260, +265, and/or +274 according to the numbering of Bacillus amyloliquefaciens subtilisin, as described in WO 95/10615 published Apr. 20, 1995 by Genencor International (A. Baeck et al. entitled “Protease-Containing Cleaning Compositions” having U.S. Ser. No. 08/322,676, filed Oct. 13, 1994).

Useful proteases are also described in PCT publications: WO 95/30010 published Nov. 9, 1995 by The Procter & Gamble Company; WO 95/30011 published Nov. 9, 1995 by The Procter & Gamble Company; WO 95/29979 published Nov. 9, 1995 by The Procter & Gamble Company.

Protease enzyme may be incorporated into the compositions in accordance with the invention at a level of from 0.0001% to 2% active enzyme by weight of the composition.

Amylase—Amylases (α and/or β) can be included for removal of carbohydrate-based stains. Suitable amylases are Termamyl® (Novo Nordisk), Fungamyl® and BAN® (Novo Nordisk). The enzymes may be of any suitable origin, such as vegetable, animal, bacterial, fungal and yeast origin. Amylase enzymes are normally incorporated in the detergent composition at levels from 0.0001% to 2%, preferably from about 0.0001% to about 0.5%, more preferably from about 0.0005% to about 0.1%, even more preferably from about 0.001% to about 0.05% of active enzyme by weight of the detergent composition.

Amylase enzymes also include those described in WO95/26397 and in co-pending application by Novo Nordisk PCT/DK96/00056.

One suitable amylase enzyme is NATALASE® available from Novo Nordisk.

Other amylases suitable herein include, for example, α-amylases described in GB 1,296,839 to Novo; RAPIDASE®, International Bio-Synthetics, Inc. and TERMAMYL®, Novo. FUNGAMYL®D from Novo is especially useful.

Particularly preferred amylases herein include amylase variants having additional modification in the immediate parent as described in WO 9510603 A and are available from the assignee, Novo, as DURAMYL®. Other particularly preferred oxidative stability enhanced amylase include those described in WO 9418314 to Genencor International and WO 9402597 to Novo. Any other oxidative stability-enhanced amylase can be used, for example as derived by site-directed mutagenesis from known chimeric, hybrid or simple mutant parent forms of available amylases. Other preferred enzyme modifications are accessible. See WO 9509909 A to Novo.

Various carbohydrase enzymes which impart antimicrobial activity may also be included in the present invention. Such enzymes include endoglycosidase, Type II endoglycosidase and glucosidase as disclosed in U.S. Pat. Nos. 5,041,236, 5,395,541, 5,238,843 and 5,356,803 the disclosures of which are herein incorporated by reference. Of course, other enzymes having antimicrobial activity may be employed as well including peroxidases, oxidases and various other enzymes.

It is also possible to include an enzyme stabilization system into the compositions of the present invention when any enzyme is present in the composition.

Various carbohydrase enzymes which impart antimicrobial activity may also be included in the present invention. Such enzymes include endoglycosidase, Type II endoglycosidase and glucosidase as disclosed in U.S. Pat. Nos. 5,041,236, 5,395,541, 5,238,843 and 5,356,803 the disclosures of which are herein incorporated by reference. Of course, other enzymes having antimicrobial activity may be employed as well including peroxidases, oxidases and various other enzymes.

It is also possible to include an enzyme stabilization system into the compositions of the present invention when any enzyme is present in the composition.

Peroxidase enzymes can be used in combination with oxygen sources, e.g., percarbonate, perborate, persulfate, hydrogen peroxide, etc. They are typically used for “solution bleaching,” i.e. to prevent transfer of dyes or pigments removed from substrates during wash operations to other substrates in the wash solution. Peroxidase enzymes are known in the art, and include, for example, horseradish peroxidase, ligninase, and haloperoxidase such as chloro- and bromo-peroxidase. Peroxidase-containing detergent compositions are disclosed, for example, in PCT International Application WO 89/099813, published Oct. 19, 1989, by O. Kirk, assigned to Novo Industries A/S. The present invention encompasses peroxidase-free automatic dishwashing composition embodiments.

A wide range of enzyme materials and means for their incorporation into synthetic detergent compositions are also disclosed in U.S. Pat. No. 3,553,139, issued Jan. 5, 1971 to McCarty et al. Enzymes are further disclosed in U.S. Pat. No. 4,101,457, Place et al, issued Jul. 18, 1978, and in U.S. Pat. No. 4,507,219, Hughes, issued Mar. 26, 1985. Enzymes for use in detergents can be stabilized by various techniques. Enzyme stabilization techniques are disclosed and exemplified in U.S. Pat. No. 3,600,319, issued Aug. 17, 1971 to Gedge, et al, and European Patent Application Publication No. 0 199 405, Application No. 86200586.5, published Oct. 29, 1986, Venegas. Enzyme stabilization systems are also described, for example, in U.S. Pat. No. 3,519,570.

The enzymes may be incorporated into detergent compositions herein in the form of suspensions, “marumes” or “prills”. Another suitable type of enzyme comprises those in the form of slurries of enzymes in nonionic surfactants, e.g., the enzymes marketed by Novo Nordisk under the tradename “SL” or the microencapsulated enzymes marketed by Novo Nordisk under the tradename “LDP.”

Enzymes added to the compositions herein in the form of conventional enzyme prills are especially preferred for use herein. Such prills will generally range in size from about 100 to 1,000 microns, more preferably from about 200 to 800 microns and will be suspended throughout the non-aqueous liquid phase of the composition. Prills in the compositions of the present invention have been found, in comparison with other enzyme forms, to exhibit especially desirable enzyme stability in terms of retention of enzymatic activity over time. Thus, compositions which utilize enzyme prills need not contain conventional enzyme stabilizing such as must frequently be used when enzymes are incorporated into aqueous liquid detergents.

If employed, enzymes will normally be incorporated into the non-aqueous liquid compositions herein at levels sufficient to provide up to about 10 mg by weight, more typically from about 0.01 mg to about 5 mg, of active enzyme per gram of the composition. Stated otherwise, the non-aqueous liquid detergent compositions herein will typically comprise from about 0.001% to 5%, preferably from about 0.01% to 1% by weight, of a commercial enzyme preparation. Protease enzymes, for example, are usually present in such commercial preparations at levels sufficient to provide from 0.005 to 0.1 Anson units (AU) of activity per gram of composition.

Enzyme Stabilizing System—The enzyme-containing compositions herein may optionally also comprise from about 0.001% to about 10%, preferably from about 0.005% to about 8%, most preferably from about 0.01% to about 6%, by weight of an enzyme stabilizing system. The enzyme stabilizing system can be any stabilizing system which is compatible with the detersive enzyme. Such a system may be inherently provided by other formulation actives, or be added separately, e.g., by the formulator or by a manufacturer of detergent-ready enzymes. Such stabilizing systems can, for example, comprise calcium ion, boric acid, propylene glycol, short chain carboxylic acids, boronic acids, and mixtures thereof, and are designed to address different stabilization problems depending on the type and physical form of the detergent composition.

Perfumes—Perfumes and perfumery ingredients useful in the present compositions and processes comprise a wide variety of natural and synthetic chemical ingredients, including, but not limited to, aldehydes, ketones, esters, and the like. Also included are various natural extracts and essences which can comprise complex mixtures of ingredients, such as orange oil, lemon oil, rose extract, lavender, musk, patchouli, balsamic essence, sandalwood oil, pine oil, cedar, and the like. Finished perfumes can comprise extremely complex mixtures of such ingredients. Finished perfumes typically comprise from about 0.01% to about 2%, by weight, of the detergent compositions herein, and individual perfumery ingredients can comprise from about 0.0001% to about 90% of a finished perfume composition.

Dispersant Polymer—The compositions of the present invention may additionally contain a dispersant polymer. When present, a dispersant polymer in the instant compositions is typically at levels in the range from 0 to about 25%, preferably from about 0.5% to about 20%, more preferably from about 1% to about 8% by weight of the composition. Dispersant polymers are useful for improved filming performance of the present compositions, especially in higher pH embodiments, such as those in which wash pH exceeds about 9.5. Particularly preferred are polymers which inhibit the deposition of calcium carbonate or magnesium silicate on dishware.

Dispersant polymers suitable for use herein are further illustrated by the film-forming polymers described in U.S. Pat. No. 4,379,080 (Murphy), issued Apr. 5, 1983.

Suitable polymers are preferably at least partially neutralized or alkali metal, ammonium or substituted ammonium (e.g., mono-, di- or triethanolammonium) salts of polycarboxylic acids. The alkali metal, especially sodium salts are most preferred. While the molecular weight of the polymer can vary over a wide range, it preferably is from about 1,000 to about 500,000, more preferably is from about 1,000 to about 250,000, and most preferably, especially if the composition is for use in North American automatic dishwashing appliances, is from about 1,000 to about 5,000.

Other suitable dispersant polymers include those disclosed in U.S. Pat. Nos. 3,308,067, 4,530,766, 3,723,322, 3,929,107, 3,803,285, 3,629,121, 4,141,841, and 5,084,535; EP Pat. No. 66,915.

Copolymers of acrylamide and acrylate having a molecular weight of from about 3,000 to about 100,000, preferably from about 4,000 to about 20,000, and an acrylamide content of less than about 50%, preferably less than about 20%, by weight of the dispersant polymer can also be used.

Particularly preferred dispersant polymers are low molecular weight modified polyacrylate copolymers.

Suitable low molecular weight polyacrylate dispersant polymer preferably has a molecular weight of less than about 15,000, preferably from about 500 to about 10,000, most preferably from about 1,000 to about 5,000. The most preferred polyacrylate copolymer for use herein has a molecular weight of about 3,500 and is the fully neutralized form of the polymer comprising about 70% by weight acrylic acid and about 30% by weight methacrylic acid.

Other dispersant polymers useful herein include the polyethylene glycols and polypropylene glycols having a molecular weight of from about 950 to about 30,000 which can be obtained from the Dow Chemical Company of Midland, Mich.

Yet other dispersant polymers useful herein include the cellulose sulfate esters such as cellulose acetate sulfate, cellulose sulfate, hydroxyethyl cellulose sulfate, methylcellulose sulfate, and hydroxypropylcellulose sulfate. Sodium cellulose sulfate is the most preferred polymer of this group.

Yet another group of acceptable dispersants are the organic dispersant polymers, such as polyaspartate.

Material Care Agents—When the compositions of the present invention are automatic dishwashing compositions they may contain one or more material care agents which are effective as corrosion inhibitors and/or anti-tarnish aids. Such materials are preferred components of machine dishwashing compositions especially in certain European countries where the use of electroplated nickel silver and sterling silver is still comparatively common in domestic flatware, or when aluminium protection is a concern and the composition is low in silicate. Generally, such material care agents include metasilicate, silicate, bismuth salts, manganese salts, paraffin, triazoles, pyrazoles, thiols, mercaptans, aluminium fatty acid salts, and mixtures thereof.

When present, such protecting materials are preferably incorporated at low levels, e.g., from about 0.01% to about 5% of the composition. Suitable corrosion inhibitors include paraffin oil, typically a predominantly branched aliphatic hydrocarbon having a number of carbon atoms in the range of from about 20 to about 50; preferred paraffin oil is selected from predominantly branched C₂₅₋₄₅ species with a ratio of cyclic to noncyclic hydrocarbons of about 32:68. A paraffin oil meeting those characteristics is sold by Wintershall, Salzbergen, Germany, under the trade name WINOG 70. Additionally, the addition of low levels of bismuth nitrate (i.e., Bi(NO₃)₃) is also preferred.

Other corrosion inhibitor compounds include benzotriazole and comparable compounds; mercaptans or thiols including thionaphtol and thioanthranol; and finely divided Aluminium fatty acid salts, such as aluminium tristearate. The formulator will recognize that such materials will generally be used judiciously and in limited quantities so as to avoid any tendency to produce spots or films on glassware or to compromise the bleaching action of the compositions. For this reason, mercaptan anti-tarnishes which are quite strongly bleach-reactive and common fatty carboxylic acids which precipitate with calcium in particular are preferably avoided.

Chelating Agents—The detergent compositions herein may also optionally contain one or more iron and/or manganese chelating agents. Such chelating agents can be selected from the group consisting of amino carboxylates, amino phosphonates, polyfunctionally-substituted aromatic chelating agents and mixtures therein, all as hereinafter defined. Without intending to be bound by theory, it is believed that the benefit of these materials is due in part to their exceptional ability to remove iron and manganese ions from washing solutions by formation of soluble chelates.

Amino carboxylates useful as optional chelating agents include ethylenediaminetetracetates, N-hydroxyethylethylenediaminetriacetates, nitrilo-tri-acetates, ethylenediamine tetrapro-prionates, triethylenetetraaminehexacetates, diethylenetriaminepentaacetates, and ethanoldi-glycines, alkali metal, ammonium, and substituted ammonium salts therein and mixtures therein.

Amino phosphonates are also suitable for use as chelating agents in the compositions of the invention when at lease low levels of total phosphorus are permitted in detergent compositions, and include ethylenediaminetetrakis (methylenephosphonates) as DEQUEST. Preferred, these amino phosphonates to not contain alkyl or alkenyl groups with more than about 6 carbon atoms.

Polyfunctionally-substituted aromatic chelating agents are also useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelator for use herein is ethylenediamine disuccinate (“EDDS”), especially the [S,S] isomer as described in U.S. Pat. No. 4,704,233, Nov. 3, 1987, to Hartman and Perkins.

The compositions herein may also contain water-soluble methyl glycine diacetic acid (MGDA) salts (or acid form) as a chelant or co-builder. Similarly, the so called “weak” builders such as citrate can also be used as chelating agents.

If utilized, these chelating agents will generally comprise from about 0.1% to about 15% by weight of the detergent compositions herein. More preferably, if utilized, the chelating agents will comprise from about 0.1% to about 3.0% by weight of such compositions.

Composition pH

The compositions and methods of the present invention may be used in compositions which cover a wide range, from acidic to basic and all shades in-between. The compositions of the present invention can have a pH from 2 to 12. If a composition with a pH greater than 7 is to be more effective, it preferably should contain a buffering agent capable of providing a generally more alkaline pH in the composition and in dilute solutions, i.e., about 0.1% to 0.4% by weight aqueous solution, of the composition. The pKa value of this buffering agent should be about 0.5 to 1.0 pH units below the desired pH value of the composition (determined as described above). Preferably, the pKa of the buffering agent should be from about 7 to about 10. Under these conditions the buffering agent most effectively controls the pH while using the least amount thereof. Similarly, an acidic buffering system can be employed to maintain the compositions pH.

The buffering agent may be an active detergent in its own right, or it may be a low molecular weight, organic or inorganic material that is used in this composition solely for maintaining an alkaline pH. One type of preferred buffering agents for compositions of this invention are nitrogen-containing materials. Some examples are amino acids such as lysine or lower alcohol amines like mono-, di-, and tri-ethanolamine. Other preferred nitrogen-containing buffering agents are Tri(hydroxymethyl)amino methane (HOCH2)3CNH3 (TRIS), 2-amino-2-ethyl-1,3-propanediol, 2-amino-2-methyl-propanol, 2-amino-2-methyl-1,3-propanol, disodium glutamate, N-methyl diethanolamide, 1,3-diamino-propanol N,N′-tetra-methyl-1,3-diamino-2-propanol, N,N-bis(2-hydroxyethyl)glycine (bicine) and N-tris (hydroxymethyl)methyl glycine (tricine). Mixtures of any of the above are also acceptable. Useful inorganic buffers/alkalinity sources include the alkali metal carbonates and alkali metal phosphates, e.g., sodium carbonate, sodium polyphosphate. Also suitable are organic acids like citric acid, acetic acid and the like. For additional buffers see McCutcheon's EMULSIFIERS AND DETERGENTS, North American Edition, 1997, McCutcheon Division, MC Publishing Company Kirk and WO 95/07971 both of which are incorporated herein by reference.

One highly preferred group of buffers, especially in LDL compositions, are diamines. Preferred organic diamines are those in which pK1 and pK2 are in the range of about 8.0 to about 11.5, preferably in the range of about 8.4 to about 11, even more preferably from about 8.6 to about 10.75. Preferred materials for performance and supply considerations are 1,3-bis(methylamine)-cyclohexane, 1,3 propane diamine (pK1=10.5; pK2=8.8), 1,6 hexane diamine (pK1=11; pK2=10), 1,3 pentane diamine (Dytek EP) (pK1=10.5; pK2=8.9), 2-methyl 1,5 pentane diamine (Dytek A) (pK1=11.2; pK2=10.0). Other preferred materials are the primary/primary diamines with alkylene spacers ranging from C4 to C8. In general, it is believed that primary diamines are preferred over secondary and tertiary diamines.

Definition of pK1 and pK2—As used herein, “pKa1” and “pKa2” are quantities of a type collectively known to those skilled in the art as “pKa” pKa is used herein in the same manner as is commonly known to people skilled in the art of chemistry. Values referenced herein can be obtained from literature, such as from “Critical Stability Constants: Volume 2, Amines” by Smith and Martel, Plenum Press, NY and London, 1975. Additional information on pKa's can be obtained from relevant company literature, such as information supplied by Dupont, a supplier of diamines. More detailed information of pKa's can be found in U.S. patent application Ser. No. 08/770,972 filed Dec. 29, 1996 to Procter & Gamble (Attorney Docket No. 6459)

Examples of preferred diamines include the following:
dimethyl aminopropyl amine, 1,6-hexane diamine, 1,3 propane diamine, 2-methyl 1,5 pentane diamine, 1,3-Pentanediamine, 1,3-diaminobutane, 1,2-bis(2-aminoethoxy)ethane, Isophorone diamine, 1,3-bis(methylamine)-cyclohexane and mixtures thereof.

The buffer can be complemented (i.e. for improved sequestration in hard water) by other optional detergency builder salts selected from nonphosphate detergency builders known in the art, which include the various water-soluble, alkali metal, ammonium or substituted ammonium borates, hydroxysulfonates, polyacetates, and polycarboxylates. Preferred are the alkali metal, especially sodium, salts of such materials. Alternate water-soluble, non-phosphorus organic builders can be used for their sequestering properties. Examples of polyacetate and polycarboxylate builders are the sodium, potassium, lithium, ammonium and substituted ammonium salts of ethylenediamine tetraacetic acid; nitrilotriacetic acid, tartrate monosuccinic acid, tartrate disuccinic acid, oxydisuccinic acid, carboxymethoxysuccinic acid, mellitic acid, and sodium benzene polycarboxylate salts.

The buffering agent, if used, is present in the compositions of the invention herein at a level of from about 0.1% to 15%, preferably from about 1% to 10%, most preferably from about 2% to 8%, by weight of the composition. If the optional buffer used is a diamine, the composition will preferably contain at least about 0.1%, more preferably at least about 0.2%, even more preferably, at least about 0.25%, even more preferably still, at least about 0.5% by weight of said composition of diamine. The composition will also preferably contain no more than about 15%, more preferably no more than about 10%, even more preferably, no more than about 6%, even more preferably, no more than about 5%, even more preferably still, no more than about 1.5% by weight of said composition of diamine.

Water-Soluble Silicates

The present compositions may further comprise water-soluble silicates. Water-soluble silicates herein are any silicates which are soluble to the extent that they do not adversely affect spotting/filming characteristics of the composition.

Examples of silicates are sodium metasilicate and, more generally, the alkali metal silicates, particularly those having a SiO₂:Na₂O ratio in the range 1.6:1 to 3.2:1; and layered silicates, such as the layered sodium silicates described in U.S. Pat. No. 4,664,839, issued May 12, 1987 to H. P. Rieck. NaSKS-6® is a crystalline layered silicate marketed by Hoechst (commonly abbreviated herein as “SKS-6”). Unlike zeolite builders, Na SKS-6 and other water-soluble silicates usefule herein do not contain aluminum. NaSKS-6 is the δ-Na₂SiO₅ form of layered silicate and can be prepared by methods such as those described in German DE-A-3,417,649 and DE-A-3,742,043. SKS-6 is a preferred layered silicate for use herein, but other such layered silicates, such as those having the general formula NaMSiₓO₂ₓ₊₁.yH₂O wherein M is sodium or hydrogen, x is a number from 1.9 to 4, preferably 2, and y is a number from 0 to 20, preferably 0 can be used. Various other layered silicates from Hoechst include NaSKS-5, NaSKS-7 and NaSKS-11, as the α-, β- and γ-forms. Other silicates may also be useful, such as for example magnesium silicate, which can serve as a crispening agent in granular formulations, as a stabilizing agent for oxygen bleaches, and as a component of suds control systems.

Silicates particularly useful in automatic dishwashing (ADD) applications include granular hydrous 2-ratio silicates such as BRITESIL®1H₂O from PQ Corp., and the commonly sourced BRITES® H24 though liquid grades of various silicates can be used when the ADD composition has liquid form. Within safe limits, sodium metasilicate or sodium hydroxide alone or in combination with other silicates may be used in an ADD context to boost wash pH to a desired level.

Bleaching Agents and Bleach Activators The compositions herein preferably further contain a bleach and/or a bleach activators. Bleaches agents will typically, when present, be at levels of from about 1% to about 30%, more typically from about 5% to about 20%, of the detergent composition, especially for fabric laundering. If present, the amount of bleach activators will typically be from about 0.1% to about 60%, more typically from about 0.5% to about 40% of the composition comprising the bleaching agent-plus-bleach activator.

The bleaches used herein can be any of the bleaches useful for detergent compositions in textile cleaning, hard surface cleaning, or other cleaning purposes that are now known or become known. These include oxygen bleaches as well as other bleaching agents.

Perborate bleaches, e.g., sodium perborate (e.g., mono- or tetra-hydrate) can be used herein. Also suitable are organic or inorganic peracids. Suitable organic or inorganic peracids for use herein include: percarboxylic acids and salts; percarbonic acids and salts; perimidic acids and salts; peroxymonosulfuric acids and salts; persulphates such as monopersulfate; peroxyacids such as diperoxydodecandioic acid (DPDA); magnesium perphthalic acid; perlauric acid; phthaloyl amidoperoxy caproic acid (PAP); perbenzoic and alkylperbenzoic acids; and mixtures thereof.

One class of suitable organic peroxycarboxylic acids have the general formula: 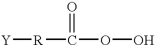
wherein R is an alkylene or substituted alkylene group containing from 1 to about 22 carbon atoms or a phenylene or substituted phenylene group, and Y is hydrogen, halogen, alkyl, aryl, —C(O)OH or —C(O)OOH.

Organic peroxyacids suitable for use in the present invention can contain either one or two peroxy groups and can be either aliphatic or aromatic. When the organic peroxycarboxylic acid is aliphatic, the unsubstituted acid has the general formula: 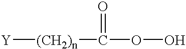
where Y can be, for example, H, CH₃, CH₂Cl, C(O)OH, or C(O)OOH; and n is an integer from 1 to 20. When the organic peroxycarboxylic acid is aromatic, the unsubstituted acid has the general formula: 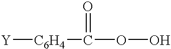
wherein Y can be, for example, hydrogen, alkyl, alkylhalogen, halogen, C(O)OH or C(O)OOH.

Typical monoperoxy acids useful herein include alkyl and aryl peroxyacids such as:
(i) peroxybenzoic acid and ring-substituted peroxybenzoic acid, e.g. peroxy-a-naphthoic acid, monoperoxyphthalic acid (magnesium salt hexahydrate), and o-carboxybenzamidoperoxyhexanoic acid (sodium salt);
(ii) aliphatic, substituted aliphatic and arylalkyl monoperoxy acids, e.g. peroxylauric acid, peroxystearic acid, N-nonanoylaminoperoxycaproic acid (NAPCA), N,N-(3-octylsuccinoyl)aminoperoxycaproic acid (SAPA) and N,N-phthaloylaminoperoxycaproic acid (PAP);
(iii) amidoperoxyacids, e.g. monononylamide of either peroxysuccinic acid (NAPSA) or of peroxyadipic acid (NAPAA).

Typical diperoxyacids useful herein include alkyl diperoxyacids and aryldiperoxyacids, such as:
(iv) 1,12-diperoxydodecanedioic acid;
(v) 1,9-diperoxyazelaic acid;
(vi) diperoxybrassylic acid; diperoxysebacic acid and diperoxyisophthalic acid;
(vii) 2-decyldiperoxybutane-1,4-dioic acid;
(viii) 4,4′-sulfonylbisperoxybenzoic acid.

Such bleaching agents are disclosed in U.S. Pat. No. 4,483,781, Hartman, issued Nov. 20, 1984, U.S. Pat. No. 4,634,551 to Burns et al., European Patent Application 0,133,354, Banks et al. published Feb. 20, 1985, and U.S. Pat. No. 4,412,934, Chung et al. issued Nov. 1, 1983. Sources also include 6-nonylamino-6-oxoperoxycaproic acid as described in U.S. Pat. No. 4,634,551, issued Jan. 6, 1987 to Burns et al. Persulfate compounds such as for example OXONE, manufactured commercially by E.I. DuPont de Nemours of Wilmington, Del. can also be employed as a suitable source of peroxymonosulfuric acid.

Particularly preferred peracid compounds are those having the formula: 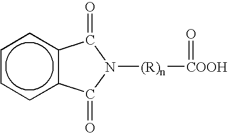
wherein R is C₁₋₄ alkyl and n is an integer of from 1 to 5. A particularly preferred peracid has the formula where R is CH₂ and n is 5 i.e., phthaloylamino peroxy caproic acid (PAP) as described in U.S. Pat. Nos. 5,487,818, 5,310,934, 5,246,620, 5,279,757 and 5,132,431. PAP is available from Ausimont SpA under the tradename Euroco.

The peracids used herein preferably have a solubility in aqueous liquid compositions measured at 20° C. of from about 10 ppm to about 1500 ppm, more preferably from about 50 ppm to about 1000 ppm, most preferably from about 50 ppm to about 800 ppm solubility is measured at 20° C.

In a particularly preferred embodiment of the present invention the peracid has mean average particle size of less than 100 microns, more preferably less than 80 microns, even more preferably less than 60 microns. Most preferably, when the peracid is PAP, it has a mean average particle size of between about 20 and about 50 microns.

Alternatively, although not preferred, the bleach can be a chlorine bleach. Chlorine bleaches can be any convenient conventional chlorine bleach. Such compounds are often divided in to two categories namely, inorganic chlorine bleaches and organic chlorine bleaches. Examples of the former are hypochlorites, such as sodium hypochlorite, calcium hypochlorite, potassium hypochlorite, magnesium hypochlorite. Another example of an inorganic chlorine bleach usable in the present invention is chlorinated trisodium phosphate dodecahydrate. Examples of the latter are isocyanurates, such as potassium dichloroisocyanurate, sodium dichloroisocyanurate. Examples of other organic chlorine bleaches usable in the present invention are 1,3-dichloro-5,5-dimethlhydantoin, N-chlorosulfamide, chloramine T, Dichloramine T, chloramine B, Dichloramine T, N,N′-dichlorobenzoylene urea, paratoluene sulfondichoroamide, trichloromethylamine, N-chloroammeline, N-chlorosuccinimide, N,N′-dichloroazodicarbonamide, N-chloroacetyl urea, N,N′-dichlorobiuret and chlorinated dicyandamide. Preferably the chlorine bleach is an inorganic chlorine bleach, more preferably it is sodium hypochlorite.

Another category of bleaches that can be used without restriction encompasses percarboxylic acid bleaching agents and salts thereof. Suitable examples of this class of agents include magnesium monoperoxyphthalate hexahydrate, the magnesium salt of metachloro perbenzoic acid, 4-nonylamino-4-oxoperoxybutyric acid and diperoxydodecanedioic acid. Such bleaches are disclosed in U.S. Pat. No. 4,483,781, Hartman, issued Nov. 20, 1984, U.S. patent application 740,446, Burns et al, filed Jun. 3, 1985, European Patent Application 0,133,354, Banks et al, published Feb. 20, 1985, and U.S. Pat. No. 4,412,934, Chung et al, issued Nov. 1, 1983. Highly preferred bleaches also include 6-nonylamino-6-oxoperoxycaproic acid as described in U.S. Pat. No. 4,634,551, issued Jan. 6, 1987 to Burns et al.

Peroxygen bleaches can also be used. Suitable peroxygen bleaching compounds include sodium carbonate peroxyhydrate and equivalent “percarbonate” bleaches, sodium pyrophosphate peroxyhydrate, urea peroxyhydrate, and sodium peroxide. Persulfate bleach (e.g., OXONE, manufactured commercially by DuPont) can also be used.

A preferred percarbonate bleach comprises dry particles having an average particle size in the range from about 500 micrometers to about 1,000 micrometers, not more than about 10% by weight of said particles being smaller than about 200 micrometers and not more than about 10% by weight of said particles being larger than about 1,250 micrometers. Optionally, the percarbonate can be coated with silicate, borate or water-soluble surfactants. Percarbonate is available from various commercial sources such as FMC, Solvay and Tokai Denka.

Mixtures of bleaches can also be used.

Peroxygen bleaches, the perborates, the percarbonates, etc., are preferably combined with bleach activators, which lead to the in situ production in aqueous solution (i.e., during the washing process) of the peroxy acid corresponding to the bleach activator. Various nonlimiting examples of activators are disclosed in U.S. Pat. No. 4,915,854, issued Apr. 10, 1990 to Mao et al, and U.S. Pat. No. 4,412,934. The nonanoyloxybenzene sulfonate (NOBS) and tetraacetyl ethylene diamine (TAED) activators are typical, and mixtures thereof can also be used. See also U.S. Pat. No. 4,634,551 for other typical bleaches and activators useful herein.

Bleach Activators

Bleach activators useful herein include amides, imides, esters and anhydrides. Commonly at least one substituted or unsubstituted acyl moiety is present, covalently connected to a leaving group as in the structure R—C(O)-L. In one preferred mode of use, bleach activators are combined with a source of hydrogen peroxide, such as the perborates or percarbonates, in a single product. Conveniently, the single product leads to in situ production in aqueous solution (i.e., during the washing process) of the percarboxylic acid corresponding to the bleach activator. The product itself can be hydrous, for example a powder, provided that water is controlled in amount and mobility such that storage stability is acceptable. Alternately, the product can be an anhydrous solid or liquid. In another mode, the bleach activator or oxygen bleach is incorporated in a pretreatment product, such as a stain stick; soiled, pretreated substrates can then be exposed to further treatments, for example of a hydrogen peroxide source. With respect to the above bleach activator structure RC(O)L, the atom in the leaving group connecting to the peracid-forming acyl moiety R(C)O— is most typically O or N. Bleach activators can have non-charged, positively or negatively charged peracid-forming moieties and/or noncharged, positively or negatively charged leaving groups. One or more peracid-forming moieties or leaving-groups can be present. See, for example, U.S. Pat. No. 5,595,967, U.S. Pat. No. 5,561,235, U.S. Pat. No. 5,560,862 or the bis-(peroxy-carbonic) system of U.S. Pat. No. 5,534,179. Mixtures of suitable bleach activators can also be used. Bleach activators can be substituted with electron-donating or electron-releasing moieties either in the leaving-group or in the peracid-forming moiety or moieties, changing their reactivity and making them more or less suited to particular pH or wash conditions. For example, electron-withdrawing groups such as NO₂ improve the efficacy of bleach activators intended for use in mild-pH (e.g., from about 7.5- to about 9.5) wash conditions.

An extensive and exhaustive disclosure of suitable bleach activators and suitable leaving groups, as well as how to determine suitable activators, can be found in U.S. Pat. Nos. 5,686,014 and 5,622,646.

Cationic bleach activators include quaternary carbamate-, quaternary carbonate-, quaternary ester- and quaternary amide-types, delivering a range of cationic peroxyimidic, peroxycarbonic or peroxycarboxylic acids to the wash. An analogous but non-cationic palette of bleach activators is available when quaternary derivatives are not desired. In more detail, cationic activators include quaternary ammonium-substituted activators of WO 96-06915, U.S. Pat. Nos. 4,751,015 and 4,397,757, EP-A-284292, EP-A-331,229 and EP-A-03520. Also useful are cationic nitriles as disclosed in EP-A-303,520 and in European Patent Specification 458,396 and 464,880. Other nitrile types have electron-withdrawing substituents as described in U.S. Pat. No. 5,591,378.

Other bleach activator disclosures include GB 836,988; 864,798; 907,356; 1,003,310 and 1,519,351; German Patent 3,337,921; EP-A-0185522; EP-A-0174132; EP-A-0120591; U.S. Pat. Nos. 1,246,339; 3,332,882; 4,128,494; 4,412,934 and 4,675,393, and the phenol sulfonate ester of alkanoyl aminoacids disclosed in U.S. Pat. No. 5,523,434. Suitable bleach activators include any acetylated diamine types, whether hydrophilic or hydrophobic in character.

Of the above classes of bleach precursors, preferred classes include the esters, including acyl phenol sulfonates, acyl alkyl phenol sulfonates or acyl oxybenzenesulfonates (OBS leaving-group); the acyl-amides; and the quaternary ammonium substituted peroxyacid precursors including the cationic nitriles.

Preferred bleach activators include N,N,N′N′-tetraacetyl ethylene diamine (TAED) or any of its close relatives including the triacetyl or other unsymmetrical derivatives. TAED and the acetylated carbohydrates such as glucose pentaacetate and tetraacetyl xylose are preferred hydrophilic bleach activators. Depending on the application, acetyl triethyl citrate, a liquid, also has some utility, as does phenyl benzoate.

Preferred hydrophobic bleach activators include sodium nonanoyloxybenzene sulfonate (NOBS or SNOBS), N-(alkanoyl)aminoalkanoyloxy benzene sulfonates, such as 4-[N-(nonanoyl)aminohexanoyloxy]-benzene sulfonate or (NACA-OBS) as described in U.S. Pat. No. 5,534,642 and in EPA 0 355 384 A1, substituted amide types described in detail hereinafter, such as activators related to NAPAA, and activators related to certain imidoperacid bleaches, for example as described in U.S. Pat. No. 5,061,807, issued Oct. 29, 1991 and assigned to Hoechst Aktiengesellschaft of Frankfurt, Germany and Japanese Laid-Open Patent Application (Kokai) No. 4-28799.

Another group of peracids and bleach activators herein are those derivable from acyclic imidoperoxycarboxylic acids and salts thereof, See U.S. Pat. No. 5,415,796, and cyclic imidoperoxycarboxylic acids and salts thereof, see U.S. Pat. Nos. 5,061,807, 5,132,431, 5,6542,69, 5,246,620, 5,419,864 and 5,438,147.

Other suitable bleach activators include sodium-4-benzoyloxy benzene sulfonate (SBOBS); sodium-1-methyl-2-benzoyloxy benzene-4-sulphonate; sodium-4-methyl-3-benzoyloxy benzoate (SPCC); trimethyl ammonium toluyloxy-benzene sulfonate; or sodium 3,5,5-trimethyl hexanoyloxybenzene sulfonate (STHOBS).

Bleach activators may be used in an amount of up to 20%, preferably from 0.1-10% by weight, of the composition, though higher levels, 40% or more, are acceptable, for example in highly concentrated bleach additive product forms or forms intended for appliance automated dosing.

Highly preferred bleach activators useful herein are amide-substituted and an extensive and exhaustive disclosure of these activators can be found in U.S. Pat. Nos. 5,686,014 and 5,622,646.

Other useful activators, disclosed in U.S. Pat. No. 4,966,723, are benzoxazin-type, such as a C₆H₄ ring to which is fused in the 1,2-positions a moiety —C(O)OC(R¹)═N—. A highly preferred activator of the benzoxazin-type is:

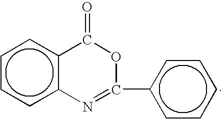

Depending on the activator and precise application, good bleaching results can be obtained from bleaching systems having with in-use pH of from about 6 to about 13, preferably from about 9.0 to about 10.5. Typically, for example, activators with electron-withdrawing moieties are used for near-neutral or sub-neutral pH ranges. Alkalis and buffering agents can be used to secure such pH.

Acyl lactam activators are very useful herein, especially the acyl caprolactams (see for example WO 94-28102 A) and acyl valerolactams (see U.S. Pat. No. 5,503,639). See also U.S. Pat. No. 4,545,784 which discloses acyl caprolactams, including benzoyl caprolactam adsorbed into sodium perborate. In certain preferred embodiments of the invention, NOBS, lactam activators, imide activators or amide-functional activators, especially the more hydrophobic derivatives, are desirably combined with hydrophilic activators such as TAED, typically at weight ratios of hydrophobic activator: TAED in the range of 1:5 to 5:1, preferably about 1:1. Other suitable lactam activators are alpha-modified, see WO 96-22350 A1, Jul. 25, 1996. Lactam activators, especially the more hydrophobic types, are desirably used in combination with TAED, typically at weight ratios of amido-derived or caprolactam activators: TAED in the range of 1:5 to 5:1, preferably about 1:1. See also the bleach activators having cyclic amidine leaving-group disclosed in U.S. Pat. No. 5,552,556.

Nonlimiting examples of additional activators useful herein are to be found in U.S. Pat. No. 4,915,854, U.S. Pat. Nos. 4,412,934 and 4,634,551. The hydrophobic activator nonanoyloxybenzene sulfonate (NOBS) and the hydrophilic tetraacetyl ethylene diamine (TAED) activator are typical, and mixtures thereof can also be used.

Additional activators useful herein include those of U.S. Pat. No. 5,545,349, which is also incorporated herein by reference.

Bleaches other than oxygen bleaching agents are also known in the art and can be utilized herein. One type of non-oxygen bleaching agent of particular interest includes photoactivated bleaches such as the sulfonated zinc and/or aluminum phthalocyanines.

See U.S. Pat. No. 4,033,718, issued Jul. 5, 1977 to Holcombe et al. If used, detergent compositions will typically contain from about 0.025% to about 1.25%, by weight, of such bleaches, especially sulfonate zinc phthalocyanine.

Bleach Catalysts

The present invention compositions and methods may optionally utilize metal-containing bleach catalysts that are effective for use in ADD, laundry or bleaching compositions. Preferred are manganese and cobalt-containing bleach catalysts.

For examples of suitable bleach catalysts see U.S. Pat. Nos. 4,246,612, 5,804,542, 5,798,326, 5,246,621, 4,430,243, 5,244,594, 5,597,936, 5,705,464, 4,810,410, 4,601,845, 5,194,416, 5,703,030, 4,728,455, 4,711,748, 4,626,373, 4,119,557, 5,114,606, 5,599,781, 5,703,034, 5,114,611, 4,430,243, 4,728,455, and 5,227,084; EP Pat. Nos. 408,131, 549,271, 384,503, 549,272, 224,952, and 306,089; DE Pat. No. 2,054,019; CA Pat No. 866,191.

Preferred are cobalt (III) catalysts having the formula:
Co[(NH₃)ₙM′ₘB′_{b}T′ₜQ_{q}Pₚ]Y_{y}
wherein cobalt is in the +3 oxidation state; n is an integer from 0 to 5 (preferably 4 or 5; most preferably 5); M′ represents a monodentate ligand; m is an integer from 0 to 5 (preferably 1 or 2; most preferably 1); B′ represents a bidentate ligand; b is an integer from 0 to 2; T′ represents a tridentate ligand; t is 0 or 1; Q is a tetradentate ligand; q is 0 or 1; P is a pentadentate ligand; p is 0 or 1; and n+m+2b+3t+4q+5p=6; Y is one or more appropriately selected counteranions present in a number y, where y is an integer from 1 to 3 (preferably 2 to 3; most preferably 2 when Y is a −1 charged anion), to obtain a charge-balanced salt, preferred Y are selected from the group consisting of chloride, iodide, I₃⁻, formate, nitrate, nitrite, sulfate, sulfite, citrate, acetate, carbonate, bromide, PF₆⁻, BF₄⁻, B(Ph)₄⁻, phosphate, phosphite, silicate, tosylate, methanesulfonate, and combinations thereof [optionally, Y can be protonated if more than one anionic group exists in Y, e.g., HPO₄²⁻, HCO₃⁻, H₂PO₄⁻, etc., and further, Y may be selected from the group consisting of non-traditional inorganic anions such as anionic surfactants, e.g., linear alkylbenzene sulfonates (LAS), alkyl sulfates (AS), alkylethoxysulfonates (AES), etc., and/or anionic polymers, e.g., polyacrylates, polymethacrylates, etc.]; and wherein further at least one of the coordination sites attached to the cobalt is labile under automatic dishwashing use conditions and the remaining coordination sites stabilize the cobalt under automatic dishwashing conditions such that the reduction potential for cobalt (III) to cobalt (II) under alkaline conditions is less than about 0.4 volts (preferably less than about 0.2 volts) versus a normal hydrogen electrode.

Preferred cobalt catalysts of this type have the formula:
[Co(NH₃)ₙ(M′)ₘ]Y_{y}
wherein n is an integer from 3 to 5 (preferably 4 or 5; most preferably 5); M′ is a labile coordinating moiety, preferably selected from the group consisting of chlorine, bromine, hydroxide, water, and (when m is greater than 1) combinations thereof; m is an integer from 1 to 3 (preferably 1 or 2; most preferably 1); m+n=6; and Y is an appropriately selected counteranion present in a number y, which is an integer from 1 to 3 (preferably 2 to 3; most preferably 2 when Y is a −1 charged anion), to obtain a charge-balanced salt.

The preferred cobalt catalyst of this type useful herein are cobalt pentaamine chloride salts having the formula [Co(NH₃)₅Cl]Y_{y}, and especially [Co(NH₃)₅Cl]Cl₂.

More preferred are the present invention compositions which utilize cobalt (III) bleach catalysts having the formula:
[Co(NH₃)ₙ(M)ₘ(B)_{b}]T_{y}
wherein cobalt is in the +3 oxidation state; n is 4 or 5 (preferably 5); M is one or more ligands coordinated to the cobalt by one site; m is 0, 1 or 2 (preferably 1); B is a ligand coordinated to the cobalt by two sites; b is 0 or 1 (preferably 0), and when b=0, then m+n=6, and when b=1, then m=0 and n=4; and T is one or more appropriately selected counteranions present in a number y, where y is an integer to obtain a charge-balanced salt (preferably y is 1 to 3; most preferably 2 when T is a −1 charged anion); and wherein further said catalyst has a base hydrolysis rate constant of less than 0.23 M⁻¹ₛ⁻¹ (25° C.).

The most preferred cobalt catalyst useful herein are cobalt pentaamine acetate salts having the formula [Co(NH₃)₅OAc]T_{y}, wherein OAc represents an acetate moiety, and especially cobalt pentaamine acetate chloride, [Co(NH₃)₅OAc]Cl₂; as well as [Co(NH₃)₅OAc](OAc)₂; [Co(NH₃)₅OAc](PF₆)₂; [Co(NH₃)₅OAc](SO₄); [Co(NH₃)₅OAc](BF₄)₂; and [Co(NH₃)₅OAc](NO₃)₂.

As a practical matter, and not by way of limitation, the cleaning compositions and cleaning processes herein can be adjusted to provide on the order of at least one part per hundred million of the active bleach catalyst species, when present, in the aqueous washing medium, and will more preferably provide from about 0.01 ppm to about 25 ppm, more preferably from about 0.05 ppm to about 10 ppm, and most preferably from about 0.1 ppm to about 5 ppm, of the bleach catalyst species in the wash liquor. In order to obtain such levels in the wash liquor of an automatic dishwashing process, typical automatic dishwashing compositions herein will comprise from about 0.0005% to about 0.2%, more preferably from about 0.004% to about 0.08%, of bleach catalyst by weight of the cleaning compositions.

Reducing Bleaches

Another class of useful bleaches are the so called reducing bleaches. These are reductants which “reduce”, in the electrochemical sense, instead of oxidize as conventional bleaches do. Examples of suitable reducing bleaches can be found in These are extensively illustrated in Kirk Othmer, Encyclopedia of Chemical Technology, Vol. 17, John Wiley and Sons, 1982.

Builders—Builders can operate via a variety of mechanisms including forming soluble or insoluble complexes with hardness ions, by ion exchange, and by offering a surface more favorable to the precipitation of hardness ions than are the surfaces of articles to be cleaned. Builder level can vary widely depending upon end use and physical form of the composition. For example, high-surfactant formulations can be unbuilt. The level of builder can vary widely depending upon the end use of the composition and its desired physical form. The compositions will comprise at least about 0.1%, preferably from about 1% to about 90%, more preferably from about 5% to about 80%, even more preferably from about 10% to about 40% by weight, of the detergent builder. Lower or higher levels of builder, however, are not excluded.

Suitable builders herein can be selected from the group consisting of phosphates and polyphosphates, especially the sodium salts; carbonates, bicarbonates, sesquicarbonates and carbonate minerals other than sodium carbonate or sesquicarbonate; organic mono-, di-, tri-, and tetracarboxylates especially water-soluble nonsurfactant carboxylates in acid, sodium, potassium or alkanolammonium salt form, as well as oligomeric or water-soluble low molecular weight polymer carboxylates including aliphatic and aromatic types; and phytic acid. These may be complemented by borates, e.g., for pH-buffering purposes, or by sulfates, especially sodium sulfate and any other fillers or carriers which may be important to the engineering of stable surfactant and/or builder-containing detergent compositions.

Builder mixtures, sometimes termed “builder systems” can be used and typically comprise two or more conventional builders, optionally complemented by chelants, pH-buffers or fillers, though these latter materials are generally accounted for separately when describing quantities of materials herein. In terms of relative quantities of surfactant and builder in the present granular compositions, preferred builder systems are typically formulated at a weight ratio of surfactant to builder of from about 60:1 to about 1:80. Certain preferred granular detergents have said ratio in the range 0.90:1.0 to 4.0:1.0, more preferably from 0.95:1.0 to 3.0:1.0.

P-containing detergent builders often preferred where permitted by legislation include, but are not limited to, the alkali metal, ammonium and alkanolammonium salts of polyphosphates exemplified by the tripolyphosphates, pyrophosphates, glassy polymeric meta-phosphates; and phosphonates. Where phosphorus-based builders can be used, the various alkali metal phosphates such as the well-known sodium tripolyphosphates, sodium pyrophosphate and sodium orthophosphate can be used. Phosphonate builders such as ethane-1-hydroxy-1,1-diphosphonate and other known phosphonates (see, for example, U.S. Pat. Nos. 3,159,581; 3,213,030; 3,422,021; 3,400,148 and 3,422,137) can also be used though such materials are more commonly used in a low-level mode as chelants or stabilizers.

Phosphate detergent builders for use in granular compositions are well known. They include, but are not limited to, the alkali metal, ammonium and alkanolammonium salts of polyphosphates (exemplified by the tripolyphosphates, pyrophosphates, and glassy polymeric meta-phosphates). Phosphate builder sources are described in detail in Kirk Othmer, 3rd Edition, Vol. 17, pp. 426-472 and in “Advanced Inorganic Chemistry” by Cotton and Wilkinson, pp. 394-400 (John Wiley and Sons, Inc.; 1972).

Preferred levels of phosphate builders herein are from about 10% to about 75%, preferably from about 15% to about 50%, of phosphate builder.

Phosphate builders can optionally be included in the compositions herein to assist in controlling mineral hardness. Builders are typically used in automatic dishwashing to assist in the removal of particulate soils.

Suitable carbonate builders include alkaline earth and alkali metal carbonates as disclosed in German Patent Application No. 2,321,001 published on Nov. 15, 1973, although sodium bicarbonate, sodium carbonate, sodium sesquicarbonate, and other carbonate minerals such as trona or any convenient multiple salts of sodium carbonate and calcium carbonate such as those having the composition 2Na₂CO₃.CaCO₃ when anhydrous, and even calcium carbonates including calcite, aragonite and vaterite, especially forms having high surface areas relative to compact calcite may be useful, for example as seeds. Various grades and types of sodium carbonate and sodium sesquicarbonate may be used, certain of which are particularly useful as carriers for other ingredients, especially detersive surfactants.

Suitable organic detergent builders include polycarboxylate compounds, including water-soluble nonsurfactant dicarboxylates and tricarboxylates. More typically builder polycarboxylates have a plurality of carboxylate groups, preferably at least 3 carboxylates. Carboxylate builders can be formulated in acid, partially neutral, neutral or overbased form. When in salt form, alkali metals, such as sodium, potassium, and lithium, or alkanolammonium salts are preferred. Polycarboxylate builders include the ether polycarboxylates, such as oxydisuccinate, see Berg, U.S. Pat. No. 3,128,287, Apr. 7, 1964, and Lamberti et al, U.S. Pat. No. 3,635,830, Jan. 18, 1972; “TMS/TDS” builders of U.S. Pat. No. 4,663,071, Bush et al, May 5, 1987; and other ether carboxylates including cyclic and alicyclic compounds, such as those described in U.S. Pat. Nos. 3,923,679; 3,835,163; 4,158,635; 4,120,874 and 4,102,903.

Other suitable builders are the ether hydroxypolycarboxylates, copolymers of maleic anhydride with ethylene or vinyl methyl ether; 1, 3, 5-trihydroxy benzene-2, 4, 6-trisulphonic acid; carboxymethyloxysuccinic acid; the various alkali metal, ammonium and substituted ammonium salts of polyacetic acids such as ethylenediamine tetraacetic acid and nitrilotriacetic acid; as well as mellitic acid, succinic acid, oxydisuccinic acid, polymaleic acid, benzene 1,3,5-tricarboxylic acid, carboxymethyloxysuccinic acid, and soluble salts thereof.

Citrates, e.g., citric acid and soluble salts thereof are important carboxylate builders due to availability from renewable resources and biodegradability. Citrates can also be used in the present granular compositions, especially in combination with zeolite and/or layered silicates. Citrates can also be used in combination with zeolite, the hereafter mentioned BRITESIL types, and/or layered silicate builders. Oxydisuccinates are also useful in such compositions and combinations. Oxydisuccinates are also especially useful in such compositions and combinations.

Where permitted alkali metal phosphates such as sodium tripolyphosphates, sodium pyrophosphate and sodium orthophosphate can be used. Phosphonate builders such as ethane-1-hydroxy-1,1-diphosphonate and other known phosphonates, e.g., those of U.S. Pat. Nos. 3,159,581; 3,213,030; 3,422,021; 3,400,148 and 3,422,137 can also be used and may have desirable antiscaling properties.

Certain detersive surfactants or their short-chain homologs also have a builder action. For unambiguous formula accounting purposes, when they have surfactant capability, these materials are summed up as detersive surfactants. Preferred types for builder functionality are illustrated by: 3,3-dicarboxy-4-oxa-1,6-hexanedioates and the related compounds disclosed in U.S. Pat. No. 4,566,984, Bush, Jan. 28, 1986. Succinic acid builders include the C₅-C₂₀ alkyl and alkenyl succinic acids and salts thereof. Succinate builders also include: laurylsuccinate, myristylsuccinate, palmitylsuccinate, 2-dodecenylsuccinate (preferred), 2-pentadecenylsuccinate, and the like. Lauryl-succinates are described in European Patent Application 86200690.5/0,200,263, published Nov. 5, 1986. Fatty acids, e.g., C₁₂-C₁₈ monocarboxylic acids, can also be incorporated into the compositions as surfactant/builder materials alone or in combination with the aforementioned builders, especially citrate and/or the succinate builders, to provide additional builder activity but are generally not desired. Such use of fatty acids will generally result in a diminution of sudsing in laundry compositions, which may need to be taken into account by the formulator. Fatty acids or their salts are undesirable in Automatic Dishwashing (ADD) embodiments in situations wherein soap scums can form and be deposited on dishware. Other suitable polycarboxylates are disclosed in U.S. Pat. No. 4,144,226, Crutchfield et al, Mar. 13, 1979 and in U.S. Pat. No. 3,308,067, Diehl, Mar. 7, 1967. See also Diehl, U.S. Pat. No. 3,723,322.

Other types of inorganic builder materials which can be used have the formula (Mₓ)ᵢCa_{y} (CO₃)_{z} wherein x and i are integers from 1 to 15, y is an integer from 1 to 10, z is an integer from 2 to 25, Mᵢ are cations, at least one of which is a water-soluble, and the equation Σᵢ=₁₋₁₅(xᵢ multiplied by the valence of Mᵢ)+2y=2z is satisfied such that the formula has a neutral or “balanced” charge. These builders are referred to herein as “Mineral Builders”. Waters of hydration or anions other than carbonate may be added provided that the overall charge is balanced or neutral. The charge or valence effects of such anions should be added to the right side of the above equation. Preferably, there is present a water-soluble cation selected from the group consisting of hydrogen, water-soluble metals, hydrogen, boron, ammonium, silicon, and mixtures thereof, more preferably, sodium, potassium, hydrogen, lithium, ammonium and mixtures thereof, sodium and potassium being highly preferred. Nonlimiting examples of noncarbonate anions include those selected from the group consisting of chloride, sulfate, fluoride, oxygen, hydroxide, silicon dioxide, chromate, nitrate, borate and mixtures thereof. Preferred builders of this type in their simplest forms are selected from the group consisting of Na₂Ca(CO₃)₂, K₂Ca(CO₃)₂, Na₂Ca₂(CO₃)₃, NaKCa(CO₃)₂, NaKCa₂(CO₃)₃, K₂Ca₂(CO₃)₃, and combinations thereof. An especially preferred material for the builder described herein is Na₂Ca(CO₃)₂ in any of its crystalline modifications. Suitable builders of the above-defined type are further illustrated by, and include, the natural or synthetic forms of any one or combinations of the following minerals: Afghanite, Andersonite, AshcroftineY, Beyerite, Borcarite, Burbankite, Butschliite, Cancrinite, Carbocernaite, Carletonite, Davyne, DonnayiteY, Fairchildite, Ferrisurite, Franzinite, Gaudefroyite, Gaylussite, Girvasite, Gregoryite, Jouravskite, KamphaugiteY, Kettnerite, Khanneshite, LepersonniteGd, Liottite, MckelveyiteY, Microsommite, Mroseite, Natrofairchildite, Nyerereite, RemonditeCe, Sacrofanite, Schrockingerite, Shortite, Surite, Tunisite, Tuscanite, Tyrolite, Vishnevite, and Zemkorite. Preferred mineral forms include Nyererite, Fairchildite and Shortite.

Detergent builders can also be selected from aluminosilicates and silicates, for example to assist in controlling mineral, especially Ca and/or Mg, hardness in wash water or to assist in the removal of particulate soils from surfaces.

Suitable silicate builders include water-soluble and hydrous solid types and including those having chain-, layer-, or three-dimensional-structure as well as amorphous-solid or non-structured-liquid types. Preferred are alkali metal silicates, particularly those liquids and solids having a SiO₂:Na₂O ratio in the range 1.6:1 to 3.2:1, including, particularly for automatic dishwashing purposes, solid hydrous 2-ratio silicates marketed by PQ Corp. under the tradename BRITESIL®, e.g., BRITESIL H₂O; and layered silicates, e.g., those described in U.S. Pat. No. 4,664,839, May 12, 1987, H. P. Rieck. NaSKS-6, sometimes abbreviated “SKS-6”, is a crystalline layered aluminium-free δ-Na₂SiO₅ morphology silicate marketed by Hoechst and is preferred especially in granular laundry compositions. See preparative methods in German DE-A-3,417,649 and DE-A-3,742,043. Other layered silicates, such as those having the general formula NaMSiₓO₂ₓ₊₁.yH₂O wherein M is sodium or hydrogen, x is a number from 1.9 to 4, preferably 2, and y is a number from 0 to 20, preferably 0, can also or alternately be used herein. Layered silicates from Hoechst also include NaSKS-5, NaSKS-7 and NaSKS-11, as the α, β and γ layer-silicate forms. Other silicates may also be useful, such as magnesium silicate, which can serve as a crispening agent in granules, as a stabilising agent for bleaches, and as a component of suds control systems.

Also suitable for use herein are synthesized crystalline ion exchange materials or hydrates thereof having chain structure and a composition represented by the following general formula in an anhydride form: xM₂O.ySiO₂.zM′O wherein M is Na and/or K, M′ is Ca and/or Mg; y/x is 0.5 to 2.0 and z/x is 0.005 to 1.0 as taught in U.S. Pat. No. 5,427,711, Sakaguchi et al, Jun. 27, 1995.

Aluminosilicate builders are especially useful in granular compositions, but can also be incorporated in liquids, pastes or gels. Suitable for the present purposes are those having empirical formula: [M_{z}(AlO₂)_{z}(SiO₂)ᵥ].xH₂O wherein z and v are integers of at least 6, the molar ratio of z to v is in the range from 1.0 to 0.5, and x is an integer from 15 to 264. Aluminosilicates can be crystalline or amorphous, naturally-occurring or synthetically derived. An aluminosilicate production method is in U.S. Pat. No. 3,985,669, Krummel, et al, Oct. 12, 1976. Preferred synthetic crystalline aluminosilicate ion exchange materials are available as Zeolite A, Zeolite P (B), Zeolite X and, to whatever extent this differs from Zeolite P, the so-called Zeolite MAP. Natural types, including clinoptilolite, may be used. Zeolite A has the formula: Na₁₂[(AlO₂)₁₂(SiO₂)₁₂].xH₂O wherein x is from 20 to 30, especially 27. Dehydrated zeolites (x=0-10) may also be used. Preferably, the aluminosilicate has a particle size of 0.1-10 microns in diameter.

Detergent builders other than silicates can be used in the compositions herein to assist in controlling mineral hardness. They can be used in conjunction with or instead of aluminosilicates and silicates. Inorganic as well as organic builders can be used. Builders are used in automatic dishwashing to assist in the removal of particulate soils.

Inorganic or non-phosphate-containing detergent builders include, but are not limited to, phosphonates, phytic acid, carbonates (including bicarbonates and sesquicarbonates), sulfates, citrate, zeolite, and aluminosilicates.

Aluminosilicate builders may be used in the present compositions though are not preferred for automatic dishwashing detergents. (See U.S. Pat. No. 4,605,509 for examples of preferred aluminosilicates.) Aluminosilicate builders are of great importance in most currently marketed heavy duty granular detergent compositions, and can also be a significant builder ingredient in liquid detergent formulations. Aluminosilicate builders include those having the empirical formula: Na₂O.Al₂O₃.xSiO_{z}.yH₂O wherein z and y are integers of at least 6, the molar ratio of z to y is in the range from 1.0 to about 0.5, and x is an integer from about 15 to about 264.

Useful aluminosilicate ion exchange materials are commercially available. These aluminosilicates can be crystalline or amorphous in structure and can be naturally-occurring aluminosilicates or synthetically derived. A method for producing aluminosilicate ion exchange materials is disclosed in U.S. Pat. No. 3,985,669, Krummel, et al, issued Oct. 12, 1976. Preferred synthetic crystalline aluminosilicate ion exchange materials useful herein are available under the designations Zeolite A, Zeolite P (B), Zeolite MAP and Zeolite X. In another embodiment, the crystalline aluminosilicate ion exchange material has the formula: Na₁₂[(AlO₂)₁₂(SiO₂)₁₂].xH₂O wherein x is from about 20 to about 30, especially about 27. This material is known as Zeolite A. Dehydrated zeolites (x=0-10) may also be used herein. Preferably, the aluminosilicate has a particle size of about 0.1-10 microns in diameter. Individual particles can desirably be even smaller than 0.1 micron to further assist kinetics of exchange through maximization of surface area. High surface area also increases utility of aluminosilicates as adsorbents for surfactants, especially in granular compositions. Aggregates of aluminosilicate particles may be useful, a single aggregate having dimensions tailored to minimize segregation in granular compositions, while the aggregate particle remains dispersible to submicron individual particles during the wash. As with other builders such as carbonates, it may be desirable to use zeolites in any physical or morphological form adapted to promote surfactant carrier function, and appropriate particle sizes may be freely selected by the formulator.

Polymeric Soil Release Agent—The compositions according to the present invention may optionally comprise one or more soil release agents. Polymeric soil release agents are characterized by having both hydrophilic segments, to hydrophilize the surface of hydrophobic fibers, such as polyester and nylon, and hydrophobic segments, to deposit upon hydrophobic fibers and remain adhered thereto through completion of the laundry cycle and, thus, serve as an anchor for the hydrophilic segments. This can enable stains occuring subsequent to treatment with the soil release agent to be more easily cleaned in later washing procedures.

If utilized, soil release agents will generally comprise from about 0.01% to about 10% preferably from about 0.1% to about 5%, more preferably from about 0.2% to about 3% by weight, of the composition.

The following, all included herein by reference, describe soil release polymers suitable for us in the present invention. U.S. Pat. No. 5,691,298 Gosselink et al., issued Nov. 25, 1997; U.S. Pat. No. 5,599,782 Pan et al., issued Feb. 4, 1997; U.S. Pat. No. 5,415,807 Gosselink et al., issued May 16, 1995; U.S. Pat. No. 5,182,043 Morrall et al., issued Jan. 26, 1993; U.S. Pat. No. 4,956,447 Gosselink et al., issued Sep. 11, 1990; U.S. Pat. No. 4,976,879 Maldonado et al. issued Dec. 11, 1990; U.S. Pat. No. 4,968,451 Scheibel et al., issued Nov. 6, 1990; U.S. Pat. No. 4,925,577 Borcher, Sr. et al., issued May 15, 1990; U.S. Pat. No. 4,861,512 Gosselink, issued Aug. 29, 1989; U.S. Pat. No. 4,877,896 Maldonado et al., issued Oct. 31, 1989; U.S. Pat. No. 4,702,857 Gosselink et al., issued Oct. 27, 1987; U.S. Pat. No. 4,711,730 Gosselink et al., issued Dec. 8, 1987; U.S. Pat. No. 4,721,580 Gosselink issued Jan. 26, 1988; U.S. Pat. No. 4,000,093 Nicol et al., issued Dec. 28, 1976; U.S. Pat. No. 3,959,230 Hayes, issued May 25, 1976; U.S. Pat. No. 3,893,929 Basadur, issued Jul. 8, 1975; and European Patent Application 0 219 048, published Apr. 22, 1987 by Kud et al.

Further suitable soil release agents are described in U.S. Pat. No. 4,201,824 Voilland et al.; U.S. Pat. No. 4,240,918 Lagasse et al.; U.S. Pat. No. 4,525,524 Tung et al.; U.S. Pat. No. 4,579,681 Ruppert et al.; U.S. Pat. No. 4,220,918; U.S. Pat. No. 4,787,989; EP 279,134 A, 1988 to Rhone-Poulenc Chemie; EP 457,205 A to BASF (1991); and DE 2,335,044 to Unilever N.V., 1974; all incorporated herein by reference.

Clay Soil Removal/Anti-redeposition Agents—The compositions of the present invention can also optionally contain water-soluble ethoxylated amines having clay soil removal and antiredeposition properties. Granular compositions which contain these compounds typically contain from about 0.01% to about 10.0% by weight of the water-soluble ethoxylates amines; liquid detergent compositions typically contain about 0.01% to about 5%.

Polymeric Dispersing Agents—Polymeric dispersing agents can advantageously be utilized at levels from about 0.1% to about 7%, by weight, in the compositions herein, especially in the presence of zeolite and/or layered silicate builders. Suitable polymeric dispersing agents include polymeric polycarboxylates and polyethylene glycols, although others known in the art can also be used. It is believed, though it is not intended to be limited by theory, that polymeric dispersing agents enhance overall detergent builder performance, when used in combination with other builders (including lower molecular weight polycarboxylates) by crystal growth inhibition, particulate soil release peptization, and anti-redeposition.

Polymeric polycarboxylate materials can be prepared by polymerizing or copolymerizing suitable unsaturated monomers, preferably in their acid form. Unsaturated monomeric acids that can be polymerized to form suitable polymeric polycarboxylates include acrylic acid, maleic acid (or maleic anhydride), fumaric acid, itaconic acid, aconitic acid, mesaconic acid, citraconic acid and methylenemalonic acid. The presence in the polymeric polycarboxylates herein or monomeric segments, containing no carboxylate radicals such as vinylmethyl ether, styrene, ethylene, etc. is suitable provided that such segments do not constitute more than about 40% by weight.

Particularly suitable polymeric polycarboxylates can be derived from acrylic acid. Such acrylic acid-based polymers which are useful herein are the water-soluble salts of polymerized acrylic acid. The average molecular weight of such polymers in the acid form preferably ranges from about 2,000 to 10,000, more preferably from about 4,000 to 7,000 and most preferably from about 4,000 to 5,000. Water-soluble salts of such acrylic acid polymers can include, for example, the alkali metal, ammonium and substituted ammonium salts. Soluble polymers of this type are known materials. Use of polyacrylates of this type in detergent compositions has been disclosed, for example, in Diehl, U.S. Pat. No. 3,308,067, issued march 7, 1967.

Acrylic/maleic-based copolymers may also be used as a preferred component of the dispersing/anti-redeposition agent. Such materials include the water-soluble salts of copolymers of acrylic acid and maleic acid. The average molecular weight of such copolymers in the acid form preferably ranges from about 2,000 to 100,000, more preferably from about 5,000 to 75,000, most preferably from about 7,000 to 65,000. The ratio of acrylate to maleate segments in such copolymers will generally range from about 30:1 to about 1:1, more preferably from about 10:1 to 2:1. Water-soluble salts of such acrylic acid/maleic acid copolymers can include, for example, the alkali metal, ammonium and substituted ammonium salts. Soluble acrylate/maleate copolymers of this type are known materials which are described in European Patent Application No. 66915, published Dec. 15, 1982, as well as in EP 193,360, published Sep. 3, 1986, which also describes such polymers comprising hydroxypropylacrylate. Still other useful dispersing agents include the maleic/acrylic/vinyl alcohol terpolymers. Such materials are also disclosed in EP 193,360, including, for example, the 45/45/10 terpolymer of acrylic/maleic/vinyl alcohol.

Another polymeric material which can be included is polyethylene glycol (PEG). PEG can exhibit dispersing agent performance as well as act as a clay soil removal-antiredeposition agent. Typical molecular weight ranges for these purposes range from about 500 to about 100,000, preferably from about 1,000 to about 50,000, more preferably from about 1,500 to about 10,000.

Polyaspartate and polyglutamate dispersing agents may also be used, especially in conjunction with zeolite builders. Dispersing agents such as polyaspartate preferably have a molecular weight (avg.) of about 10,000.

Brightener—Any optical brighteners or other brightening or whitening agents known in the art can be incorporated at levels typically from about 0.01% to about 1.2%, by weight, into the detergent compositions herein. Commercial optical brighteners which may be useful in the present invention can be classified into subgroups, which include, but are not necessarily limited to, derivatives of stilbene, pyrazoline, coumarin, carboxylic acid, methinecyanines, dibenzothiophene-5,5-dioxide, azoles, 5- and 6-membered-ring heterocycles, and other miscellaneous agents. Examples of such brighteners are disclosed in “The Production and Application of Fluorescent Brightening Agents”, M. Zahradnik, Published by John Wiley & Sons, New York (1982).

Specific examples of optical brighteners which are useful in the present compositions are those identified in U.S. Pat. No. 4,790,856, issued to Wixon on Dec. 13, 1988. These brighteners include the PHORWHITE series of brighteners from Verona. Other brighteners disclosed in this reference include: Tinopal UNPA, Tinopal CBS and Tinopal 5BM; available from Ciba-Geigy; Artic White CC and Artic White CWD, the 2-(4-styryl-phenyl)-2H-naptho[1,2-d]triazoles; 4,4′-bis-(1,2,3-triazol-2-yl)-stilbenes; 4,4′-bis(styryl)bisphenyls; and the aminocoumarins. Specific examples of these brighteners include 4-methyl-7-diethyl-amino coumarin; 1,2-bis(benzimidazol-2-yl)ethylene; 1,3-diphenyl-pyrazolines; 2,5-bis(benzoxazol-2-yl)thiophene; 2-styryl-naptho[1,2-d]oxazole; and 2-(stilben-4-yl)-2H-naphtho[1,2-d]triazole. See also U.S. Pat. No. 3,646,015, issued Feb. 29, 1972 to Hamilton.

Dye Transfer Inhibiting Agents—The compositions of the present invention may also include one or more materials effective for inhibiting the transfer of dyes from one fabric to another during the cleaning process. Generally, such dye transfer inhibiting agents include polyvinyl pyrrolidone polymers, polyamine N-oxide polymers, copolymers of N-vinylpyrrolidone and N-vinylimidazole, manganese phthalocyanine, peroxidases, and mixtures thereof. If used, these agents typically comprise from about 0.01% to about 10% by weight of the composition, preferably from about 0.01% to about 5%, and more preferably from about 0.05% to about 2%.

More specifically, the polyamine N-oxide polymers preferred for use herein contain units having the following structural formula: R-Aₓ-P; wherein P is a polymerizable unit to which an N—O group can be attached or the N—O group can form part of the polymerizable unit or the N—O group can be attached to both units; A is one of the following structures: —NC(O)—, —C(O)O—, —S—, —O—, —N═; x is 0 or 1; and R is aliphatic, ethoxylated aliphatics, aromatics, heterocyclic or alicyclic groups or any combination thereof to which the nitrogen of the N-0 group can be attached or the N-0 group is part of these groups. Preferred polyamine N-oxides are those wherein R is a heterocyclic group such as pyridine, pyrrole, imidazole, pyrrolidine, piperidine and derivatives thereof.

The N—O group can be represented by the following general structures: 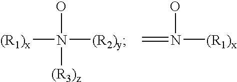
wherein R₁, R₂, R₃ are aliphatic, aromatic, heterocyclic or alicyclic groups or combinations thereof; x, y and z are 0 or 1; and the nitrogen of the N-0 group can be attached or form part of any of the aforementioned groups. The amine oxide unit of the polyamine N-oxides has a pKa<10, preferably pKa<7, more preferred pKa<6.

Any polymer backbone can be used as long as the amine oxide polymer formed is water-soluble and has dye transfer inhibiting properties. Examples of suitable polymeric backbones are polyvinyls, polyalkylenes, polyesters, polyethers, polyamide, polyimides, polyacrylates and mixtures thereof. These polymers include random or block copolymers where one monomer type is an amine N-oxide and the other monomer type is an N-oxide. The amine N-oxide polymers typically have a ratio of amine to the amine N-oxide of 10:1 to 1:1,000,000. However, the number of amine oxide groups present in the polyamine oxide polymer can be varied by appropriate copolymerization or by an appropriate degree of N-oxidation. The polyamine oxides can be obtained in almost any degree of polymerization. Typically, the average molecular weight is within the range of 500 to 1,000,000; more preferred 1,000 to 500,000; most preferred 5,000 to 100,000. This preferred class of materials can be referred to as “PVNO”.

The most preferred polyamine N-oxide useful in the detergent compositions herein is poly(4-vinylpyridine-N-oxide) which as an average molecular weight of about 50,000 and an amine to amine N-oxide ratio of about 1:4.

Copolymers of N-vinylpyrrolidone and N-vinylimidazole polymers (referred to as a class as “PVPVI”) are also preferred for use herein. Preferably the PVPVI has an average molecular weight range from 5,000 to 1,000,000, more preferably from 5,000 to 200,000, and most preferably from 10,000 to 20,000. (The average molecular weight range is determined by light scattering as described in Barth, et al., Chemical Analysis, Vol 113. “Modern Methods of Polymer Characterization”, the disclosures of which are incorporated herein by reference.) The PVPVI copolymers typically have a molar ratio of N-vinylimidazole to N-vinylpyrrolidone from 1:1 to 0.2:1, more preferably from 0.8:1 to 0.3:1, most preferably from 0.6:1 to 0.4:1. These copolymers can be either linear or branched.

The present invention compositions also may employ a polyvinylpyrrolidone (“PVP”) having an average molecular weight of from about 5,000 to about 400,000, preferably from about 5,000 to about 200,000, and more preferably from about 5,000 to about 50,000. PVP's are known to persons skilled in the detergent field; see, for example, EP-A-262,897 and EP-A-256,696, incorporated herein by reference. Compositions containing PVP can also contain polyethylene glycol (“PEG”) having an average molecular weight from about 500 to about 100,000, preferably from about 1,000 to about 10,000. Preferably, the ratio of PEG to PVP on a ppm basis delivered in wash solutions is from about 2:1 to about 50:1, and more preferably from about 3:1 to about 10:1.

The compositions herein may also optionally contain from about 0.005% to 5% by weight of certain types of hydrophilic optical brighteners which also provide a dye transfer inhibition action. If used, the compositions herein will preferably comprise from about 0.01% to 1% by weight of such optical brighteners.

The hydrophilic optical brighteners useful in the present invention are those having the structural formula: 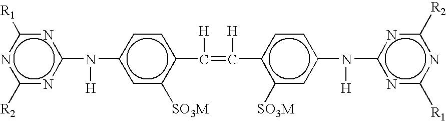
wherein R₁ is selected from anilino, N-2-bis-hydroxyethyl and NH-2-hydroxyethyl; R₂ is selected from N-2-bis-hydroxyethyl, N-2-hydroxyethyl-N-methylamino, morphilino, chloro and amino; and M is a salt-forming cation such as sodium or potassium.

When in the above formula, R₁ is anilino, R₂ is N-2-bis-hydroxyethyl and M is a cation such as sodium, the brightener is 4,4′,-bis[(4-anilino-6-(N-2-bis-hydroxyethyl)-s-triazine-2-yl)amino]-2,2′-stilbenedisulfonic acid and disodium salt. This particular brightener species is commercially marketed under the tradename Tinopal-UNPA-GX by Ciba-Geigy Corporation. Tinopal-UNPA-GX is the preferred hydrophilic optical brightener useful in the detergent compositions herein.

When in the above formula, R₁ is anilino, R₂ is N-2-hydroxyethyl-N-2-methylamino and M is a cation such as sodium, the brightener is 4,4′-bis[(4-anilino-6-(N-2-hydroxyethyl-N-methylamino)-s-triazine-2-yl)amino]2,2′-stilbenedisulfonic acid disodium salt. This particular brightener species is commercially marketed under the tradename Tinopal 5BM-GX by Ciba-Geigy Corporation.

When in the above formula, R₁ is anilino, R₂ is morphilino and M is a cation such as sodium, the brightener is 4,4′-bis[(4-anilino-6-morphilino-s-triazine-2-yl)amino]2,2′-stilbenedisulfonic acid, sodium salt. This particular brightener species is commercially marketed under the tradename Tinopal AMS-GX by Ciba Geigy Corporation.

The specific optical brightener species selected for use in the present invention provide especially effective dye transfer inhibition performance benefits when used in combination with the selected polymeric dye transfer inhibiting agents hereinbefore described. The combination of such selected polymeric materials (e.g., PVNO and/or PVPVI) with such selected optical brighteners (e.g., Tinopal UNPA-GX, Tinopal 5BM-GX and/or Tinopal AMS-GX) provides significantly better dye transfer inhibition in aqueous wash solutions than does either of these two granular composition components when used alone. Without being bound by theory, it is believed that such brighteners work this way because they have high affinity for fabrics in the wash solution and therefore deposit relatively quick on these fabrics. The extent to which brighteners deposit on fabrics in the wash solution can be defined by a parameter called the “exhaustion coefficient”. The exhaustion coefficient is in general as the ratio of a) the brightener material deposited on fabric to b) the initial brightener concentration in the wash liquor. Brighteners with relatively high exhaustion coefficients are the most suitable for inhibiting dye transfer in the context of the present invention.

Of course, it will be appreciated that other, conventional optical brightener types of compounds can optionally be used in the present compositions to provide conventional fabric “brightness” benefits, rather than a true dye transfer inhibiting effect. Such usage is conventional and well-known to detergent formulations.

Suds Suppressors—Compounds for reducing or suppressing the formation of suds can be incorporated into the compositions of the present invention. Suds suppression can be of particular importance in the so-called “high concentration cleaning process” as described in U.S. Pat. Nos. 4,489,455 and 4,489,574 and in front-loading European-style washing machines.

A wide variety of materials may be used as suds suppressors, and suds suppressors are well known to those skilled in the art. See, for example, Kirk Othmer Encyclopedia of Chemical Technology, Third Edition, Volume 7, pages 430-447 (John Wiley & Sons, Inc., 1979). One category of suds suppressor of particular interest encompasses monocarboxylic fatty acid and soluble salts therein. See U.S. Pat. No. 2,954,347, issued Sep. 27, 1960 to Wayne St. John. The monocarboxylic fatty acids and salts thereof used as suds suppressor typically have hydrocarbyl chains of 10 to about 24 carbon atoms, preferably 12 to 18 carbon atoms. Suitable salts include the alkali metal salts such as sodium, potassium, and lithium salts, and ammonium and alkanolammonium salts.

The compositions herein may also contain non-surfactant suds suppressors. These include, for example: high molecular weight hydrocarbons such as paraffin, fatty acid esters (e.g., fatty acid triglycerides), fatty acid esters of monovalent alcohols, aliphatic C₁₈-C₄₀ ketones (e.g., stearone), etc. Other suds inhibitors include N-alkylated amino triazines such as tri- to hexa-alkylmelamines or di- to tetra-alkyldiamine chlortriazines formed as products of cyanuric chloride with two or three moles of a primary or secondary amine containing 1 to 24 carbon atoms, propylene oxide, and monostearyl phosphates such as monostearyl alcohol phosphate ester and monostearyl di-alkali metal (e.g., K, Na, and Li) phosphates and phosphate esters. The hydrocarbons such as paraffin and haloparaffin can be utilized in liquid form. The liquid hydrocarbons will be liquid at room temperature and atmospheric pressure, and will have a pour point in the range of about −40° C. and about 50° C., and a minimum boiling point not less than about 110° C. (atmospheric pressure). It is also known to utilize waxy hydrocarbons, preferably having a melting point below about 100° C. The hydrocarbons constitute a preferred category of suds suppressor for detergent compositions. Hydrocarbon suds suppressors are described, for example, in U.S. Pat. No. 4,265,779, issued May 5, 1981 to Gandolfo et al. The hydrocarbons, thus, include aliphatic, alicyclic, aromatic, and heterocyclic saturated or unsaturated hydrocarbons having from about 12 to about 70 carbon atoms. The term “paraffin,” as used in this suds suppressor discussion, is intended to include mixtures of true paraffins and cyclic hydrocarbons.

Another preferred category of non-surfactant suds suppressors comprises silicone suds suppressors. This category includes the use of polyorganosiloxane oils, such as polydimethylsiloxane, dispersions or emulsions of polyorganosiloxane oils or resins, and combinations of polyorganosiloxane with silica particles wherein the polyorganosiloxane is chemisorbed or fused onto the silica. Silicone suds suppressors are well known in the art and are, for example, disclosed in U.S. Pat. No. 4,265,779, issued May 5, 1981 to Gandolfo et al and European Patent Application No. 89307851.9, published Feb. 7, 1990, by Starch, M. S.

Other silicone suds suppressors are disclosed in U.S. Pat. No. 3,455,839 which relates to compositions and processes for defoaming aqueous solutions by incorporating therein small amounts of polydimethylsiloxane fluids.

Mixtures of silicone and silanated silica are described, for instance, in German Patent Application DOS 2,124,526. Silicone defoamers and suds controlling agents in granular detergent compositions are disclosed in U.S. Pat. No. 3,933,672, Bartolotta et al, and in U.S. Pat. No. 4,652,392, Baginski et al, issued Mar. 24, 1987.

An exemplary silicone based suds suppressor for use herein is a suds suppressing amount of a suds controlling agent consisting essentially of:
(i) polydimethylsiloxane fluid having a viscosity of from about 20 cs. to about 1,500 cs. at 25° C.;
(ii) from about 5 to about 50 parts per 100 parts by weight of (i) of siloxane resin composed of (CH₃)₃SiO_{1/2} units of SiO₂ units in a ratio of from (CH₃)₃ SiO_{1/2} units and to SiO₂ units of from about 0.6:1 to about 1.2:1; and
(iii) from about 1 to about 20 parts per 100 parts by weight of (i) of a solid silica gel.

In the preferred silicone suds suppressor used herein, the solvent for a continuous phase is made up of certain polyethylene glycols or polyethylene-polypropylene glycol copolymers or mixtures thereof (preferred), or polypropylene glycol. The primary silicone suds suppressor is branched/crosslinked and preferably not linear.

To illustrate this point further, typical liquid laundry detergent compositions with controlled suds will optionally comprise from about 0.001 to about 1, preferably from about 0.01 to about 0.7, most preferably from about 0.05 to about 0.5, weight % of said silicone uds suppressor, which comprises (1) a nonaqueous emulsion of a primary antifoam agent which is a mixture of (a) a polyorganosiloxane, (b) a resinous siloxane or a silicone resin-producing silicone compound, (c) a finely divided filler material, and (d) a catalyst to promote the reaction of mixture components (a), (b) and (c), to form silanolates; (2) at least one nonionic silicone surfactant; and (3) polyethylene glycol or a copolymer of polyethylene-polypropylene glycol having a solubility in water at room temperature of more than about 2 weight %; and without polypropylene glycol. Similar amounts can be used in granular compositions, gels, etc. See also U.S. Pat. No. 4,978,471, Starch, issued Dec. 18, 1990, and U.S. Pat. No. 4,983,316, Starch, issued Jan. 8, 1991, U.S. Pat. No. 5,288,431, Huber et al., issued Feb. 22, 1994, and U.S. Pat. Nos. 4,639,489 and 4,749,740, Aizawa et al at column 1, line 46 through column 4, line 35.

The silicone suds suppressor herein preferably comprises polyethylene glycol and a copolymer of polyethylene glycol/polypropylene glycol, all having an average molecular weight of less than about 1,000, preferably between about 100 and 800. The polyethylene glycol and polyethylene/polypropylene copolymers herein have a solubility in water at room temperature of more than about 2 weight %, preferably more than about 5 weight %.

The preferred solvent herein is polyethylene glycol having an average molecular weight of less than about 1,000, more preferably between about 100 and 800, most preferably between 200 and 400, and a copolymer of polyethylene glycol/polypropylene glycol, preferably PPG 200/PEG 300. Preferred is a weight ratio of between about 1:1 and 1:10, most preferably between 1:3 and 1:6, of polyethylene glycol:copolymer of polyethylene-polypropylene glycol.

The preferred silicone suds suppressors used herein do not contain polypropylene glycol, particularly of 4,000 molecular weight. They also preferably do not contain block copolymers of ethylene oxide and propylene oxide, like PLURONIC L101.

Other suds suppressors useful herein comprise the secondary alcohols (e.g., 2-alkyl alkanols) and mixtures of such alcohols with silicone oils, such as the silicones disclosed in U.S. Pat. Nos. 4,798,679, 4,075,118 and EP 150,872. The secondary alcohols include the C₆-C₁₆ alkyl alcohols having a C₁-C₁₆ chain. A preferred alcohol is 2-butyl octanol, which is available from Condea under the trademark ISOFOL 12. Mixtures of secondary alcohols are available under the trademark ISALCHEM 123 from Enichem. Mixed suds suppressors typically comprise mixtures of alcohol+silicone at a weight ratio of 1:5 to 5:1.

For any granular compositions to be used in automatic laundry washing machines, suds should not form to the extent that they overflow the washing machine. Suds suppressors, when utilized, are preferably present in a “suds suppressing amount. By “suds suppressing amount” is meant that the formulator of the composition can select an amount of this suds controlling agent that will sufficiently control the suds to result in a low-sudsing granular detergent for use in automatic laundry washing machines.

The compositions herein may comprise from 0% to about 10% of suds suppressor. When utilized as suds suppressors, monocarboxylic fatty acids, and salts therein, will be present typically in amounts up to about 5%, by weight, of the detergent composition. Preferably, from about 0.5% to about 3% of fatty monocarboxylate suds suppressor is utilized. Silicone suds suppressors are typically utilized in amounts up to about 2.0%, by weight, of the detergent composition, although higher amounts may be used. This upper limit is practical in nature, due primarily to concern with keeping costs minimized and effectiveness of lower amounts for effectively controlling sudsing. Preferably from about 0.01% to about 1% of silicone suds suppressor is used, more preferably from about 0.25% to about 0.5%. As used herein, these weight percentage values include any silica that may be utilized in combination with polyorganosiloxane, as well as any adjunct materials that may be utilized. Monostearyl phosphate suds suppressors are generally utilized in amounts ranging from about 0.1% to about 2%, by weight, of the composition. Hydrocarbon suds suppressors are typically utilized in amounts ranging from about 0.01% to about 5.0%, although higher levels can be used. The alcohol suds suppressors are typically used at 0.2%-3% by weight of the finished compositions.

Alkoxylated Polycarboxylates−Alkoxylated polycarboxylates such as those prepared from polyacrylates are useful herein to provide additional grease removal performance. Such materials are described in WO 91/08281 and PCT 90/01815 at p. 4 et seq., incorporated herein by reference. Chemically, these materials comprise polyacrylates having one ethoxy side-chain per every 7-8 acrylate units. The side-chains are of the formula —(CH₂CH₂O)ₘ(CH₂)ₙCH₃ wherein m is 2-3 and n is 6-12. The side-chains are ester-linked to the polyacrylate “backbone” to provide a “comb” polymer type structure. The molecular weight can vary, but is typically in the range of about 2000 to about 50,000.

Such alkoxylated polycarboxylates can comprise from about 0.05% to about 10%, by weight, of the compositions herein.

Antimicrobial agents—an antimicrobial agent is a compound or substance that kills microorganisms or prevents or inhibits their growth and reproduction. A properly selected antimicrobial agent maintains stability under use and storage conditions (pH, temperature, light, etc.), for a required length of time. A desirable property of the antimicrobial agent is that it is safe and nontoxic in handling, formulation and use, is environmentally acceptable and cost effective. Classes of antimicrobial agents include, but are not limited to, chlorophenols, aldehydes, biguanides, antibiotics and biologically active salts. Some preferable antimicrobial agent in the antimicrobial is bronopol, chlorhexidine diacetate, TRICOSAN.TM., hexetidine orparachlorometaxylenol (PCMX). More preferably, the antimicrobial agent is TRICOSAN.TM, chlorhexidine diacetate or hexetidine.

The antimicrobial agent, when used, is present in a microbiocidally effective amount, more preferably an from about 0.01% to about 10.0%, more preferably from about 0.1% to about 8.0%, even more preferably from about 0.5% to about 2.0%, by weight of c the composition.

Solvents.

Optionally, the compositions of the present invention may further comprise one or more solvents. These solvents may be used in conjunction with an aqueous liquid carrier or they may be used without any aqueous liquid carrier being present. Solvents are broadly defined as compounds that are liquid at temperatures of 20° C.-25° C. and which are not considered to be surfactants. One of the distinguishing features is that solvents tend to exist as discrete entities rather than as broad mixtures of compounds. Some solvents which are useful in the hard surface cleaning compositions of the present invention contain from 1 carbon atom to 35 carbon atoms, and contain contiguous linear, branched or cyclic hydrocarbon moieties of no more than 8 carbon atoms. Examples of suitable solvents for the present invention include, methanol, ethanol, propanol, isopropanol, 2-methyl pyrrolidinone, benzyl alcohol and morpholine n-oxide. Preferred among these solvents are methanol and isopropanol.

The compositions used herein may optionally contain an alcohol having a hydrocarbon chain comprising 8 to 18 carbon atoms, preferably 12 to 16. The hydrocarbon chain can be branched or linear, and can be mono, di or polyalcohols. The compositions used herein can optionally comprise from 0.1% to 3% by weight of the total composition of such alcohol, or mixtures thereof, preferably from 0.1% to 1%.

The solvents which can be used herein include all those known to the those skilled in the art of hard-surfaces cleaner compositions. Suitable solvents for use herein include ethers and diethers having from 4 to 14 carbon atoms, preferably from 6 to 12 carbon atoms, and more preferably from 8 to 10 carbon atoms. Also other suitable solvents are glycols or alkoxylated glycols, alkoxylated aromatic alcohols, aromatic alcohols, aliphatic branched alcohols, alkoxylated aliphatic branched alcohols, alkoxylated linear C₁-C₅ alcohols, linear C₁-C₅ alcohols, C₈-C₁₄ alkyl and cycloalkyl hydrocarbons and halohydrocarbons, C₆-C₁₆ glycol ethers and mixtures thereof.

Suitable glycols which can be used herein are according to the formula HO—CR1R2—OH wherein R1 and R2 are independently H or a C₂-C₁₀ saturated or unsaturated aliphatic hydrocarbon chain and/or cyclic. Suitable glycols to be used herein are dodecaneglycol and/or propanediol.

Suitable alkoxylated glycols which can be used herein are according to the formula R—(A)ₙ—R1—OH wherein R is H, OH, a linear saturated or unsaturated alkyl of from 1 to 20 carbon atoms, preferably from 2 to 15 and more preferably from 2 to 10, wherein R1 is H or a linear saturated or unsaturated alkyl of from 1 to 20 carbon atoms, preferably from 2 to 15 and more preferably from 2 to 10, and A is an alkoxy group preferably ethoxy, methoxy, and/or propoxy and n is from 1 to 5, preferably 1 to 2. Suitable alkoxylated glycols to be used herein are methoxy octadecanol and/or ethoxyethoxyethanol.

Suitable alkoxylated aromatic alcohols which can be used herein are according to the formula R(A)ₙ—OH wherein R is an alkyl substituted or non-alkyl substituted aryl group of from 1 to 20 carbon atoms, preferably from 2 to 15 and more preferably from 2 to 10, wherein A is an alkoxy group preferably butoxy, propoxy and/or ethoxy, and n is an integer of from 1 to 5, preferably 1 to 2. Suitable alkoxylated aromatic alcohols are benzoxyethanol and/or benzoxypropanol.

Suitable aromatic alcohols which can be used herein are according to the formula R—OH wherein R is an alkyl substituted or non-alkyl substituted aryl group of from 1 to 20 carbon atoms, preferably from 1 to 15 and more preferably from 1 to 10. For example a suitable aromatic alcohol to be used herein is benzyl alcohol.

Suitable aliphatic branched alcohols which can be used herein are according to the formula R−OH wherein R is a branched saturated or unsaturated alkyl group of from 1 to 20 carbon atoms, preferably from 2 to 15 and more preferably from 5 to 12. Particularly suitable aliphatic branched alcohols to be used herein include 2-ethylbutanol and/or 2-methylbutanol.

Suitable alkoxylated aliphatic branched alcohols which can be used herein are according to the formula R(A)ₙ—OH wherein R is a branched saturated or unsaturated alkyl group of from 1 to 20 carbon atoms, preferably from 2 to 15 and more preferably from 5 to 12, wherein A is an alkoxy group preferably butoxy, propoxy and/or ethoxy, and n is an integer of from 1 to 5, preferably 1 to 2. Suitable alkoxylated aliphatic branched alcohols include 1-methylpropoxyethanol and/or 2-methylbutoxyethanol.

Suitable alkoxylated linear C₁-C₅ alcohols which can be used herein are according to the formula R(A)ₙ—OH wherein R is a linear saturated or unsaturated alkyl group of from 1 to 5 carbon atoms, preferably from 2 to 4, wherein A is an alkoxy group preferably butoxy, propoxy and/or ethoxy, and n is an integer of from 1 to 5, preferably 1 to 2. Suitable alkoxylated aliphatic linear C₁-C₅ alcohols are butoxy propoxy propanol (n-BPP), butoxyethanol, butoxypropanol, ethoxyethanol or mixtures thereof. Butoxy propoxy propanol is commercially available under the trade name n-BPP® from Dow chemical.

Suitable linear C1-C5 alcohols which can be used herein are according to the formula R-OH wherein R is a linear saturated or unsaturated alkyl group of from 1 to 5 carbon atoms, preferably from 2 to 4. Suitable linear C₁-C₅ alcohols are methanol, ethanol, propanol or mixtures thereof.

Other suitable solvents include, but are not limited to, butyl diglycol ether (BDGE), butyltriglycol ether, ter amilic alcohol and the like. Particularly preferred solvents which can be used herein are butoxy propoxy propanol, butyl diglycol ether, benzyl alcohol, butoxypropanol, ethanol, methanol, isopropanol and mixtures thereof.

Typically, the compositions used in the methods of the present invention preferably comprise up to 20% by weight of the total composition of a solvent or mixtures thereof, more preferably from 0.5% to 10%, even more preferably from 3% to 10% and even more preferably still from 1% to 8%, by weight.

Other suitable solvents for use herein include propylene glycol derivatives such as n-butoxypropanol or n-butoxypropoxypropanol, water-soluble CARBITOL® solvents or water-soluble CELLOSOLVE R solvents; water-soluble CARBITOL® solvents are compounds of the 2-(2-alkoxyethoxy)ethanol class wherein the alkoxy group is derived from ethyl, propyl or butyl; a preferred water-soluble carbitol is 2-(2-butoxyethoxy)ethanol also known as butyl carbitol. Water-soluble CELLOSOLVE R solvents are compounds of the 2-alkoxyethoxy ethanol class, with 2-butoxyethoxyethanol being preferred. Other suitable solvents include benzyl alcohol, and diols such as 2-ethyl-1,3-hexanediol and 2,2,4-trimethyl-1,3-pentanediol and mixtures thereof. Some preferred solvents for use herein are n-butoxypropoxypropanol, BUTYL CARBITOL® and mixtures thereof.

The solvents can also be selected from the group of compounds comprising ether derivatives of mono-, di- and tri-ethylene glycol, propylene glycol, butylene glycol ethers, and mixtures thereof. The molecular weights of these solvents are preferably less than 350, more preferably between 100 and 300, even more preferably between 115 and 250. Examples of preferred solvents include, for example, mono-ethylene glycol n-hexyl ether, mono-propylene glycol n-butyl ether, and tri-propylene glycol methyl ether. Ethylene glycol and propylene glycol ethers are commercially available from the Dow Chemical Company under the tradename “Dowanol” and from the Arco Chemical Company under the tradename “Arcosolv”. Other preferred solvents including mono- and di-ethylene glycol n-hexyl ether are available from the Union Carbide company.

Hydrophobic Solvent

In order to improve cleaning in liquid compositions, one can use a hydrophobic solvent that has cleaning activity. The hydrophobic solvents which may be employed in the hard surface cleaning compositions herein can be any of the well-known “degreasing” solvents commonly used in, for example, the dry cleaning industry, in the hard surface cleaner industry and the metalworking industry.

A useful definition of such solvents can be derived from the solubility parameters as set forth in “The Hoy,” a publication of Union Carbide, incorporated herein by reference. The most useful parameter appears to be the hydrogen bonding parameter which is calculated by the formula:

$$γ H = γ {T [ \frac{a - 1}{a} ]}^{1 / 2}$$

wherein γH is the hydrogen bonding parameter, a is the aggregation number,

$$( Log α = 3.39066 {T}_{b} / {T}_{c} - 0.15848 - Log \frac{M}{d} ) ,$$

and γT is the solubility parameter which is obtained from the formula:

$$γ T = {[ \frac{( Δ {H}_{25} - RT ) d}{M} ]}^{1 / 2}$$

where ΔH₂₅ is the heat of vaporization at 25° C., R is the gas constant (1.987 cal/mole/deg), T is the absolute temperature in ^{o}K, T_{b} is the boiling point in ⁰K, T_{c} is the critical temperature in ^{o}K, d is the density in g/ml, and M is the molecular weight.

For the compositions herein, hydrogen bonding parameters are preferably less than 7.7, more preferably from 2 to 7, or 7.7, and even more preferably from 3 to 6. Solvents with lower numbers become increasingly difficult to solubilize in the compositions and have a greater tendency to cause a haze on glass. Higher numbers require more solvent to provide good greasy/oily soil cleaning.

Hydrophobic solvents are typically used, when present, at a level of from 0.5% to 30%, preferably from 2% to 15%, more preferably from 3% to 8%. Dilute compositions typically have solvents at a level of from 1% to 10%, preferably from 3% to 6%. Concentrated compositions contain from 10% to 30%, preferably from 10% to 20% of solvent.

Many of such solvents comprise hydrocarbon or halogenated hydrocarbon moieties of the alkyl or cycloalkyl type, and have a boiling point well above room temperature, i.e., above 20° C.

One highly preferred solvent is limonene, which not only has good grease removal but also a pleasant odor properties.

The formulator of compositions of the present type will be guided in the selection of solvent partly by the need to provide good grease-cutting properties, and partly by aesthetic considerations. For example, kerosene hydrocarbons function quite well for grease cutting in the present compositions, but can be malodorous. Kerosene must be exceptionally clean before it can be used, even in commercial situations. For home use, where malodors would not be tolerated, the formulator would be more likely to select solvents which have a relatively pleasant odor, or odors which can be reasonably modified by perfuming.

The C₆-C₉ alkyl aromatic solvents, especially the C₆-C₉ alkyl benzenes, preferably octyl benzene, exhibit excellent grease removal properties and have a low, pleasant odor. Likewise, the olefin solvents having a boiling point of at least 100° C., especially alpha-olefins, preferably 1-decene or 1-dodecene, are excellent grease removal solvents.

Generically, glycol ethers useful herein have the formula R¹¹O—(R¹²O—)ₘ1H wherein each R¹¹ is an alkyl group which contains from 3 to 8 carbon atoms, each R¹² is either ethylene or propylene, and m¹ is a number from 1 to 3. The most preferred glycol ethers are selected from the group consisting of monopropyleneglycolmonopropyl ether, dipropyleneglycolmonobutyl ether, monopropyleneglycolmonobutyl ether, ethyleneglycolmonohexyl ether, ethyleneglycolmonobutyl ether, diethyleneglycolmonohexyl ether, monoethyleneglycolmonohexyl ether, monoethyleneglycolmonobutyl ether, and mixtures thereof.

A particularly preferred type of solvent for these hard surface cleaner compositions comprises diols having from 6 to 16 carbon atoms in their molecular structure. Preferred diol solvents have a solubility in water of from 0.1 to 20 g/100 g of water at 20° C. The diol solvents in addition to good grease cutting ability, impart to the compositions an enhanced ability to remove calcium soap soils from surfaces such as bathtub and shower stall walls. These soils are particularly difficult to remove, especially for compositions which do not contain an abrasive. Other solvents such as benzyl alcohol, n-hexanol, and phthalic acid esters of C₁₋₄ alcohols can also be used.

Solvents such as pine oil, orange terpene, benzyl alcohol, n-hexanol, phthalic acid esters of C₁₋₄ alcohols, butoxy propanol, Butyl Carbitol® and 1(2-n-butoxy-1-methylethoxy)propane-2-ol (also called butoxy propoxy propanol or dipropylene glycol monobutyl ether), hexyl diglycol (Hexyl Carbitol®), butyl triglycol, diols such as 2,2,4trimethyl-1,3-pentanediol, and mixtures thereof, can be used. The butoxy-propanol solvent should have no more than 20%, preferably no more than 10%, more preferably no more than 7%, of the secondary isomer in which the butoxy group is attached to the secondary atom of the propanol for improved odor.

The level of hydrophobic solvent is preferably, when present, from 1% to 15%, more preferably from 2% to 12%, even more preferably from 5% to 10%.

Hydrotropes

The compositions used in the methods of the present invention may optionally comprise one or more materials which are hydrotropes. Hydrotropes suitable for use in the compositions herein include the C₁-C₃ alkyl aryl sulfonates, C₆-C₁₂ alkanols, C₁-C₆ carboxylic sulfates and sulfonates, urea, C₁-C₆ hydrocarboxylates, C₁-C₄ carboxylates, C₂-C₄ organic diacids and mixtures of these hydrotrope materials. The composition of the present invention preferably comprises from 0.5% to 8%, by weight of the liquid detergent composition of a hydrotrope selected from alkali metal and calcium xylene and toluene sulfonates.

Suitable C₁-C₃ alkyl aryl sulfonates include sodium, potassium, calcium and ammonium xylene sulfonates; sodium, potassium, calcium and ammonium toluene sulfonates; sodium, potassium, calcium and ammonium cumene sulfonates; and sodium, potassium, calcium and ammonium substituted or unsubstituted naphthalene sulfonates and mixtures thereof.

Suitable C₁-C₈ carboxylic sulfate or sulfonate salts are any water soluble salts or organic compounds comprising 1 to 8 carbon atoms (exclusive of substituent groups), which are substituted with sulfate or sulfonate and have at least one carboxylic group. The substituted organic compound may be cyclic, acylic or aromatic, i.e. benzene derivatives.

Preferred alkyl compounds have from 1 to 4 carbon atoms substituted with sulfate or sulfonate and have from 1 to 2 carboxylic groups. Examples of this type of hydrotrope include sulfosuccinate salts, sulfophthalic salts, sulfoacetic salts, m-sulfobenzoic acid salts and diester sulfosuccinates, preferably the sodium or potassium salts as disclosed in U.S. Pat. No. 3,915,903.

Suitable C₁-C₄ hydrocarboxylates and C₁-C₄ carboxylates for use herein include acetates and propionates and citrates. Suitable C₂-C₄ diacids for use herein include succinic, glutaric and adipic acids.

Other compounds which deliver hydrotropic effects suitable for use herein as a hydrotrope include C₆-C₁₂ alkanols and urea.

Preferred hydrotropes for use herein are sodium, potassium, calcium and ammonium cumene sulfonate; sodium, potassium, calcium and ammonium xylene sulfonate; sodium, potassium, calcium and ammonium toluene sulfonate and mixtures thereof. Most preferred are sodium cumene sulfonate and calcium xylene sulfonate and mixtures thereof. These preferred hydrotrope materials can be present in the composition to the extent of from 0.5% to 8% by weight.

The following tables further illustrate possible cleaning solutions for use in the present invention, but are not intended to be limiting thereof.

| INGREDIENTS | | | | | | |
|---|---|---|---|---|---|---|
| (weight %) | 1 | 2 | 3 | 4 | 5 | 6 |
| NaAS | — | | | | | 0.30 |
| NaAE1S | | | 0.2850 | 0.5700 | | |
| NaAE0.6S | 0.1305 | 0.1305 | | | | |
| Sodium Heptyl | | | | | 0.90 | 3.00 |
| Nonyl Sulfate | | | | | | |
| C12/14 dimethyl | 0.0325 | 0.0325 | 0.0350 | 0.0700 | 2.10 | |
| amine oxide | | | | | | |
| Fatty acid | | | | | 0.90 | |
| C11E9 | 0.0150 | 0.0150 | | | | |
| 1,3 BAC diamine | 0.0025 | 0.0025 | | | | |
| K2CO3 | 0.0038 | 0.0038 | | | | |
| Na2CO3 | 0.0088 | 0.0085 | | | | |
| NaOH | adj. | adj. | adj. | adj. | 1.00 | 0.87 |
| Limonene | 0.0225 | 0.0225 | | | | |
| Ethanol | 0.0150 | 0.0150 | 0.0625 | 0.5100 | | |
| Propylene Glycol | 0.0200 | 0.0200 | | | | |
| Butoxy Propoxy | | | 2.0000 | 2.0000 | | |
| Propanol | | | | | | |
| 1,2 Hexanediol | 0.0400 | | | | | |
| 1,3 Butoxy 2 | | 0.0400 | | | | |
| Propanediol | | | | | | |
| Sodium Cumene | 0.0200 | 0.0200 | | | | |
| Sulfonate | | | | | | |
| Sodium Xylene | | | 0.0300 | 0.0600 | | |
| Sulfonate | | | | | | |
| Mg++ | | | 0.0045 | 0.0090 | | |
| (as MgCl2) | | | | | | |
| Mg++ | | | 0.0038 | 0.0076 | | |
| (as MgSO4) | | | | | | |
| NaCl | 0.0075 | 0.0075 | | | | |
| Alkaline H2O2 | | | | 1.5000 | | |
| Stabilizer 1 | | | | | | |
| EDTA | | | | 0.0050 | | |
| Hypochlorite | | | | | 1.00 | 0.87 |
| Periodic acid | | | | | 0.01 | |
| Silicate | | | | | 0.40 | 0.04 |
| Perfume | 0.0015 | 0.0015 | | — | 0.20 | 0.35 |
| Viscosity (cps) | 1.0 | 1.0 | 1.0 | 1.0 | 500.0 | 1.0 |
| pH (10% pc) | 10.8 | 10.8 | 9.0 | 9.0 | 13.0 | 13.0 |

| INGREDIENTS | | | | | | | |
|---|---|---|---|---|---|---|---|
| (weight %) | 7 | 8 | 9 | 10 | 11 | 12 | 13 |
| NaAE0.6S | 3.92 | 4.40 | 4.40 | 4.40 | 4.40 | 26.10 | 26.10 |
| C12/14 dimethyl | 0.98 | 1.10 | 1.10 | 1.10 | 1.10 | 6.50 | 6.50 |
| amine oxide | | | | | | | |
| C11E9 | 0.45 | 0.50 | 0.50 | 0.50 | 0.50 | 3.00 | 3.00 |
| 1,3 BAC diamine | 0.08 | 0.40 | 0.40 | 0.40 | 0.40 | 0.50 | 0.50 |
| K2CO3 | | 0.13 | 0.13 | 0.13 | 0.13 | 0.75 | 0.75 |
| Na2CO3 | | 0.30 | 0.30 | 0.30 | 0.30 | 1.75 | 1.75 |
| NaOH | adj. | adj. | adj. | adj. | adj. | adj. | adj. |
| Limonene | 0.68 | 0.77 | 0.77 | 0.77 | 0.77 | 0.00 | 4.50 |
| Ethanol | | 0.50 | 0.50 | 0.50 | 0.50 | 3.00 | 3.00 |
| Propylene Glycol | 1.80 | 2.00 | 0.40 | 0.40 | 0.40 | 4.00 | 12.00 |
| Butoxy Propoxy | | | 1.60 | | | | |
| Propanol | | | | | | | |
| 1,2 Hexanediol | | | | 1.60 | | | |
| 1,3 Butoxy 2 | | | | | 1.60 | | |
| Propanediol | | | | | | | |
| Sodium Cumene | | 0.68 | | | | 4.00 | 4.00 |
| Sulfonate | | | | | | | |
| NaCl | | 0.26 | | | | 1.50 | 1.50 |
| Perfume | 0.05 | 0.05 | | | | 0.30 | 0.30 |
| Viscosity (cps) | 2.00 | 2.0 | 2.0 | 2.0 | 2.0 | 330.0 | 330.0 |
| pH (10% pc) | 10.80 | 10.8 | 10.8 | 10.8 | 10.8 | 10.8 | 10.8 |

### EXAMPLE

An ultrasonic horn originally used for cutting applications, with a length of 9 cm and a width measured at the tip of 1.5 cm, was made to ultrasonically vibrate at 50 kHz, with an amplitude of 40 micron using a standard PZT converter. The electronics driving the converter were present on a standard PCB, with a size of 5 by 5 cm, and were powered out of a 36W Li-Ion battery.

The total was assembled such that it formed a hand held combination.

A white piece of knitted cotton was stained with a 5 cm diameter circular stain of dirty motor oil, which was allowed to dry in.

A cleaning liquid was dispensed onto the stain. The cleaning liquid contained 1.5% H₂O₂, 2% of grease cleaning surfactant and was buffered at pH 9. During dispensing of the product, the stain was gently rubbed with a low rubbing frequency using the ultrasonically vibrating implement.

A total of 2 ml of cleaning solution was dispensed, and after about 2 minutes of treatment time, the total amount of soil material was removed.

The white piece of cotton was clean and did not show any residues or marks.

1. A process of cleaning a substrate, the process comprising a first step of providing a cleaning solution and a hand-held implement, the process further comprising a second step of applying the solution onto the substrate with the implement, characterised in that the implement has an active part vibrating at a frequency of at least 20 kHz with an amplitude of at least 10 μm and up to 100 μm, and whereby the substrate is fibrous or a hard domestic surface.

2. The process according to claim 1, whereby the hand-held implement has at least two configurations, a first configuration where the active part is hard, and a second configuration where the active part is not hard.

3. The process according to claim 2, whereby the second configuration is obtained by adding an extra element to the implement in the first configuration.

4. The process according to claim 3, whereby the extra element is sleeved around the active part of the first configuration.

5. The process according to any of the above claims, whereby the implement further comprises a reservoir containing a cleaning solution.

6. The process according to claim 5, whereby the reservoir is removable.

7. The process according to claim 5, whereby the active part is vibrating when the cleaning solution is delivered from the reservoir.

8. The process according to claim 1, whereby the cleaning solution comprises a surfactant and a builder.

9. The process according to claim 1, whereby the cleaning solution comprises a bleach.
